(19) United States
(12) Patent Application Publication
(10) Pub. No.: US 2026/0230328 A1
(43) Pub. Date: Aug. 6, 2026

(54) DOMAIN-ANCHORED DETERMINISTIC CANONICALIZATION CLEARING KERNEL WITH VERSIONED ROUTING, TWO-PHASE RAIL EVIDENCE, GOVERNANCE-TO-LEDGER BINDING, AND RECOMPUTABLE PROOF SETS

(71) Applicant: FURONG BEI, San Gabriel, CA (US)

(72) Inventor: FURONG BEI, San Gabriel, CA (US)

(21) Appl. No.: 19/553,337

(22) Filed: Mar. 1, 2026

(51) Int. Cl. H04L 9/32

(52) U.S. Cl. CPC H04L 9/3236; H04L 9/3213; H04L 9/3218; H04L 9/3247; H04L 2209/56

(57) ABSTRACT

A domain-anchored deterministic clearing kernel resolves a human-readable namespace address into an account container, constructs a byte-identical canonical intent envelope under a versioned canonicalization profile, computes a transaction hash, enforces a nonce anti-replay gate, and performs atomic debit-credit updates. An append-only verifiable ledger is maintained without distributed consensus by chaining block hashes as H(previous_hash∥tx_hash). A legacy-rail adapter provides two-phase bridging with mapping_version, rail_payload_digest, and rail_ack_digest under schema-governed presence rules. A governance binder cryptographically anchors policy and mapping updates to committed ledger state via update_digest and metadata_binding_hash. A verification interface returns a recomputable proof set enabling independent third-party audit of settlement integrity and governance evolution, including offline terminal capture with hash-chained receipts and black-box evidence-of-use indicators for licensing and diligence. In preferred embodiments, the versioned routing is implemented as BEIRouting for human-readable domain-anchored addressing.

### CROSS-REFERENCE TO RELATED APPLICATIONS

This application may reference, incorporate, and/or claim benefit or priority to one or more related applications filed by the Applicant/Inventor, including U.S. and international filings. Any priority/benefit claim, if asserted, is made only to the extent expressly stated in the Application Data Sheet (ADS) and/or on an accompanying priority-claims submission. For convenience only, “family inventories” and portfolio references may be listed to support diligence, mapping, and technical continuity; such references do not limit this disclosure or the claims, do not constitute an admission as to the identification or applicability of any prior filing, and do not create a priority/benefit claim unless expressly asserted. In the event of any conflict between an incorporated document and the present specification, the present specification controls. See ANNEX K for a non-limiting list of representative module-family filings grouped by topic area (such as infrastructure/protocol/clearing and ecosystem/time-assets/basepoints). This specification is an integrated disclosure. Related applications in the BEI/ATMS module family may be incorporated by reference for non-limiting embodiments, including to provide additional implementation details, alternative architectures, optional interfaces, and exemplary receipt/evidence objects consistent with the kernel-level deterministic execution model described herein. Unless expressly stated, incorporation by reference is for non-limiting embodiments and does not disclaim any scope. A non-limiting module bank index is provided in ANNEX K. MODULE BANK AND INCORPORATION BY REFERENCE (NON-LIMITING)

Illustrative Embodiments. The embodiments described herein are illustrative. The scope of the invention is defined solely by the claims and their equivalents.

No priority or benefit is claimed by virtue of this Module Bank; any priority claim, if any, is set forth only in the Application Data Sheet.

### Terminology and Definitions

Terminology Lock. The following terms are defined for clarity and are intended to be used consistently across the Specification, Claims, and Drawings. Unless expressly stated, the terms are and may include equivalent implementations that preserve the deterministic evidence-binding semantics described herein.

Background Framing; No Admission. The following background discussion is provided for context and does not constitute an admission of prior art or an admission that any described system is known, analogous, or relevant.

Replay and duplicate submissions can occur due to retries and message reordering unless a strict nonce gate predicate is enforced per account container. Distributed ledger systems provide auditability but often require distributed consensus, increasing computational cost and complexity. There remains a need for an append-only verifiable ledger that enables third-party recomputation without reliance on distributed consensus. Accordingly, there is a need for a deterministic clearing kernel that (i) resolves a namespace address (domain namespace+account identifier) to an account container; (ii) constructs a byte-identical canonical intent envelope under a canonicalization profile; (iii) computes tx_hash and verifies a signature; (iv) enforces a nonce gate; (v) binds mapping_version, rail_payload_digest, and rail_ack_digest for legacy rail interactions; and (vi) returns a proof set via a verification interface. Long-felt technical need is evidenced by recurring operational incidents where the same economic intent results in different digests across clients, causing downstream reconciliation failures. The disclosed kernel removes such divergence by binding canonicalization profile and canonical_profile_id to every proof-carrying receipt record. III. SUMMARY A namespace address resolver parses an input namespace address and resolves an account container holding public key, balance, and nonce. A canonicalization profile engine applies a canonicalization profile to produce a byte-identical canonical intent envelope reproducible by independent verifiers. A cryptographic verification engine computes transaction hash (tx_hash) from the canonical intent envelope and verifies a digital signature over tx_hash using the account container public key. A nonce gate admits execution only when nonce_requested equals nonce_stored plus one. A deterministic execution engine updates balances and emits a receipt record containing tx_hash and status metadata. An append-only verifiable ledger engine computes block_hash by hashing a byte-concatenation of previous_hash and tx_hash and appends a ledger block without distributed consensus. A legacy rail adapter maps the namespace address to a rail endpoint under mapping_version and binds rail_payload_digest and rail_ack_digest into the receipt record and/or ledger.

A verification interface returns a proof set including previous_hash, block_hash, hash_function_id, and canonical_profile_id enabling recomputation of H(byte-concatenation of previous_hash and tx_hash).

### IV. BRIEF DESCRIPTION OF THE DRAWINGS

FIG. 1 illustrates an overall architecture including canonicalization profile engine, nonce gate, legacy rail adapter, append-only verifiable ledger, and verification interface.

FIG. 2 illustrates parsing of namespace address and computation of address_hash.

FIG. 3 illustrates account container, receipt record, and ledger block data structures.

FIG. 4 illustrates deterministic transfer and two-phase bridging (prepare/commit) with mapping_version, rail_payload_digest, and rail_ack_digest.

FIG. 5 illustrates canonical intent envelope construction under a canonicalization profile.

FIG. 6 illustrates computation of block_hash as H(byte-concatenation of previous_hash and tx_hash).

FIG. 7 illustrates the verification interface proof set including hash_function_id and canonical_profile_id.

FIGS. 8-12 illustrate nonce gate/anti-replay gating, verification interface variants (including a governance-enhanced proof set), terminal device embodiment, and offline capture and later synchronization.

### REFERENCE NUMERALS LEGEND

In some embodiments, drawings may include reference numerals to aid court-grade citation. The following legend maps representative modules to numerals.

| Reference numeral | Module |
|---|---|
| 100 | Namespace Address Resolver |
| 110 | Account Container Store |
| 120 | Canonicalization Profile Engine |
| 130 | Cryptographic Verification Engine |
| 140 | Nonce Gate / Idempotency Gate |
| 150 | Deterministic Execution Engine |
| 160 | Append-only Verifiable Ledger |
| 170 | Legacy Rail Adapter |
| 180 | Verification Interface |
| 190 | Proof Set (returned object) |
| 200 | Terminal Device |
| 210 | Offline Capture Buffer / Receipt Chain |
| 220 | Offline Pre-Authorization Token |
| 230 | Conformance Record / Registry Entry |
| 240 | Governance Binder |

### V. DEFINITIONS

### V.A Hierarchical Account Graph, Inheritance, and Settlement

A hierarchical account graph includes parent and child account nodes connected by directed edges representing containment, delegation, or ownership. A path within the hierarchical account graph denotes an ordered sequence of nodes from a root (or scoped parent) to a selected account node. Each node may be associated with parameters, constraints, and policy pointers. The term ‘effective parameter set’ denotes the deterministically computed parameter values applicable to a selected node for a given evaluation context.

An inheritance rule engine applies a deterministic precedence rule set to compute the effective parameter set. Inheritance may be evaluated along a path in the hierarchical account graph using an ordered precedence table such as: (i) explicit override at the selected node; (ii) nearest-parent override along the path; (iii) scoped defaults at a domain or industry boundary; and (iv) system defaults. Ties are resolved deterministically by a fixed rule order and a stable node ordering.

A settlement matrix denotes a deterministic allocation mapping bound to the hierarchical account graph. The settlement matrix may specify, for a given transaction class and policy snapshot, how value is distributed among nodes (such as treasury, fees, rebates, withholding, and counterparty postings). The settlement matrix may be represented as a sparse matrix or rule table keyed by node class, edge type, and transaction class.

### V.B Policy Snapshots and Routing Keys

A policy snapshot identifier (snapshot_id) binds at least: (i) policy_version_id, (ii) an effective time window, and (iii) a digest of the effective parameter set produced by inheritance. The time window may be expressed as [t_start, t_end] and may be derived from time_hash rules. A unified routing key is a machine-executable key material that incorporates snapshot_id and a key version, and may further include replay-prevention material (such as nonce material) and a time-to-live value to bound reuse.

V.C Deterministic Risk Finite-State machine and Reason Code's

A deterministic risk finite-state machine (risk FSM) evaluates one or more risk constraints prior to an atomic commit boundary. The risk FSM operates over a closed set of states and transitions and emits reason codes indicating pass, block, defer, or manual review outcomes. The risk FSM is deterministic with respect to a policy snapshot and declared input features, such that independent verifiers can reproduce the decision path and reason codes given the same evidence objects.

Behavioral Economics Identity (BEI): a domain-anchored identity namespace framework used to scope addressing, policy boundaries, and evidence objects in certain embodiments.

BEI routing (BEIRouting): an exemplary versioned routing gateway for resolving human-readable namespace addresses (e.g., account_id@namespace) into deterministic routing endpoints under mapping_version; illustrative namespace examples include beirouting.com. domain namespace: a resolvable namespace string used to scope account addressing and policy boundaries.

account identifier: an identifier that, together with a domain namespace, resolves an account container.

namespace address: a human-readable address derived from (domain namespace, account identifier), including formats namespace/account_id and account_id@namespace.

account container: a data structure storing at least public key, balance, and nonce for an account identifier within a domain namespace.

canonicalization profile: a declared deterministic rule set for normalization and fixed field ordering used to construct a canonical intent envelope.

canonicalization profile engine: a component that applies the canonicalization profile to inputs to produce a byte-identical canonical intent envelope.

canonical intent envelope: the byte-identical canonical form of an intent produced under a canonicalization profile.

transaction hash (tx_hash): a cryptographic digest computed from the canonical intent envelope. nonce gate: an anti-replay predicate admitting execution only when nonce_requested==nonce_stored+1.

receipt record: a proof-carrying record emitted after deterministic processing, including tx_hash and status metadata and in some embodiments mapping_version and rail digests.

previous_hash: the prior block_hash in an append-only verifiable ledger (or a GENESIS value).

block_hash: computed by hashing a byte-concatenation of previous_hash and tx_hash for a ledger block.

verification interface: an interface that returns a proof set enabling a third party to recompute H(byte-concatenation of previous_hash and tx_hash).

proof set: returned data including at least tx_hash, previous_hash, block_hash, hash_function_id, and canonical_profile_id.

legacy rail adapter: a module mapping a namespace address to a rail endpoint under mapping_version and computing rail_payload_digest and rail_ack_digest.

mapping_version: a version identifier associated with a deterministic mapping rule set.

rail_payload_digest: digest of a rail-specific payload derived from canonical fields.

rail_ack_digest: digest of a rail acknowledgement bound to a receipt record and/or ledger.

hash_function_id: an identifier indicating the cryptographic hash function used for tx_hash, block_hash, and rail digests.

canonical_profile_id: a version identifier indicating the canonicalization profile used to produce the canonical intent envelope.

### VI. SYSTEM OVERVIEW

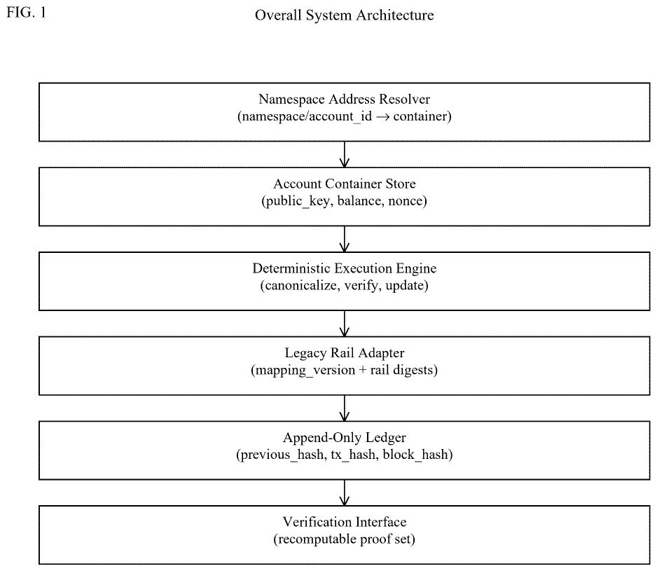

Architecture. In one embodiment (FIG. 1), the system comprises a namespace address resolver, an account container store, a canonicalization profile engine, a cryptographic verification engine, a nonce gate, a deterministic execution engine, an append-only verifiable ledger engine, a legacy rail adapter, and a verification interface.

Domain anchoring. The term domain-anchored refers to use of a domain namespace as an addressing scope; the disclosed kernel does not require any particular DNS modification and may operate at an application layer while preserving deterministic proofs across systems.

Deterministic boundary. The system defines a deterministic boundary at the canonical intent envelope: once constructed under the declared canonicalization profile and canonical_profile_id, independent verifiers can reproduce the same bytes and therefore the same tx_hash.

Evidence first design. Each processed intent yields a receipt record and (in some embodiments) a ledger block; both are proof-carrying objects intended to be recomputed and validated by third parties via the verification interface.
A verification interface returns proof sets enabling independent recomputation of tx_hash and integrity anchors for audit and diligence.
Governance-to-ledger binding makes rule evolution independently verifiable, preventing silent policy drift.
Two-phase bridging binds rail_payload_digest and rail_ack_digest to evidence objects, improving reconciliation across heterogeneous legacy rails.
Nonce gating and idempotency semantics support safe retries under network reordering without double execution at the atomic commit boundary.
Deterministic canonicalization prevents digest divergence across clients by enforcing byte-identical canonical intent envelopes under canonical_profile_id.

### VI.A Objective Technical Effects

Conventional routing keys are not deterministically bound to a policy snapshot, canonicalization profile, and presence-variable field presence rules for audit replay.
Conventional ledgers may be append-only but do not bind governance/rule evolution into integrity evidence objects verifiable by recomputation.
Conventional payment rails provide settlement outcomes but do not expose recomputable proof sets for independent third-party verification.

### VI.B Distinguishers Over Conventional Systems

Representative conventional payment routing and clearing approaches rely on numeric identifiers and standardized interbank messaging protocols. Such systems commonly encounter technical challenges including elevated risk of human entry errors due to non-intuitive numeric formats, reconciliation discrepancies arising from inconsistent transaction digest representations across heterogeneous client implementations, absence of portable recomputable proof sets enabling independent third-party audit without privileged database access, and constrained support for verifiable offline terminal synchronization. Additionally, updates to routing rules, mapping parameters, or compliance policies may be effected through off-ledger mechanisms without cryptographic anchoring to committed transaction states.

The disclosed deterministic clearing kernel addresses these longstanding technical deficiencies through domain-anchored human-readable namespace addressing with verifiable resolver transcript digests, enforcement of byte-identical canonical intent envelopes under versioned canonical_profile_id, two-phase legacy rail evidence binding with schema-governed presence rules, governance-to-ledger cryptographic binding via update_digest and metadata_binding_hash, and offline cache digest chaining with pre-authorization tokens. These features collectively enable safe retries, deterministic error paths, and independent recomputation of both settlement integrity and rule evolution, providing concrete improvements in auditability, reconciliation efficiency, and system interoperability over conventional approaches.

The foregoing comparison is provided for technical context and does not constitute an admission of prior art.
Claim 19 (governance binder): XVI/XVII (Governance/Policy Binding sections if present) and Annex A.
Claim 18 (offline token): XV (Terminal Device, Offline Capture, and Synchronization).
Claim 4: XIV (Legacy Rail Adapter and Two-Phase Bridging).
Claim 1 verification interface and proof set: XIII (Verification Interface and Proof Set).
Claim 12: XII (Append-Only Verifiable Ledger).
Claim 1(f)-(g) and Claim 2(g)-(h): X (Nonce Gate, Idempotency) and XI (Deterministic Execution).
Claim 1(d) and Claim 2(e): VIII (Canonicalization Profile) and IX (Cryptographic Verification).
Claim 1(a)-(c): VII (Namespace Address Resolution) and VI (System Overview).

### VI.C Claim-to-Support Map

The following map is provided to facilitate review of written description and enablement support; it does not limit claim scope.

| | Key limitation | Primary support sections |
|---|---|---|
| Claim | (illustrative) | (illustrative) |
| Claim 1 | Hierarchical namespace | VI, VII, VIII, IX, X, XI, XIII; |
| | graph + policy snapshot + | Annex A A.2-A.8 |
| | canonicalization + proof_set | |
| | verification interface | |
| Claim 4 | Two-phase rail evidence | XIV; Annex A A.6 |
| | binding (rail_payload_digest + | |
| | rail_ack_digest) under | |
| | mapping_version | |
| Claim 12 | Append-only tamper-evident | XII; Annex A A.6 |
| | log / integrity anchors | |
| Claim 19 | Governance-to-ledger | Annex A A.7-A.7.2 |
| | binding (update_digest + | |
| | metadata_binding_hash) and | |
| | verification procedure | |
| Claim 20 | Conformance profile + | Annex A A.8-A.9 |
| | receipt verifier interface + | |
| | test vectors | |

### VI.D Design-Around Resistance and Equivalent Implementations

Namespace addressing is not limited to DNS; alternative namespace types (such as DID documents, public keys, bank identifiers, or versioned directories) may be used provided resolution and evidence binding remain deterministic.
presence-variable field presence rules are versioned and evidence-bound (such as presence_rule_id) such that omission/injection of presence-variable fields cannot defeat audit replay.
Idempotency is evidence-based: repeated submissions return prior receipt record/proof_set without applying state mutation, preventing retry-induced double execution.
Governance and routing evolution are evidence objects: mapping_version and policy_version_id updates are bound via update_digest and metadata_binding_hash for independent verification.

### VI.E Kernel Invariants and Verification Predicates

invariants include: (i) canonical_intent_envelope bytes are uniquely determined by inputs and canonical_profile_id; (ii) nonce gate predicate admits execution only when nonce_requested equals nonce_stored plus one; (iii) block_hash binds previous_hash and tx_hash via a declared hash_function_id; (iv) if governance binding is enabled, metadata_binding_hash binds block_hash and update_digest. A verifier recomputes these predicates using proof_set data to validate commit outcomes without privileged internal access.

### VII. NAMESPACE ADDRESS RESOLUTION

In some embodiments, the domain namespace is an illustrative namespace anchor. A namespace anchor may alternatively be represented by a DID method prefix, a URI authority, a certificate subject namespace, an organization identifier, or another signed namespace scope that deterministically resolves to an account container. The term ‘domain namespace’ herein refers to one class of namespace anchors and does not restrict the claims to a specific DNS implementation.

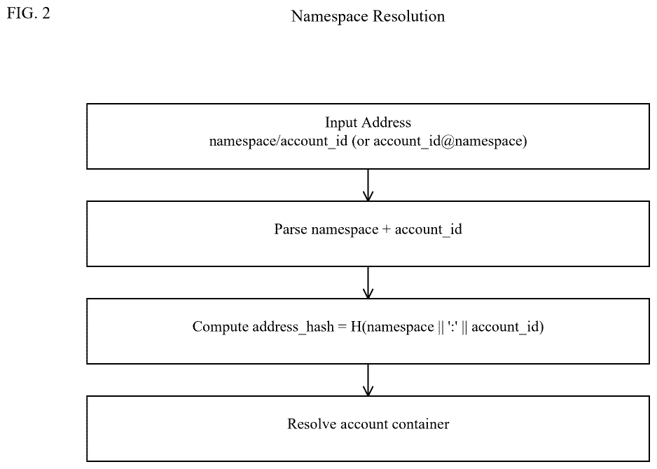

Parsing (FIG. 2). The resolver parses a namespace address into domain namespace and account identifier. A delimiter policy is applied deterministically; in one example, if the input contains ‘/’, then the substring before ‘/’ is the domain namespace and the substring after ‘/’ is the account identifier.

Normalization. The resolver normalizes the parsed domain namespace and account identifier under the canonicalization profile, including case policy, Unicode normalization policy, and whitespace policy.

Lookup key. In some embodiments, address_hash is computed by hashing a byte-concatenation of domain_namespace, a delimiter, and account identifier is computed and used as a lookup key into the account container store.

Account container store. The store returns an account container comprising at least public key field, balance field, and nonce field. The nonce field is monotonically increasing per account identifier within a domain namespace.

### VII.A Namespace Anchor Registry and Resolver Transcript Disgust Acceptance

In some embodiments, namespace anchors are verified using a namespace anchor registry and a resolver transcript digest. This acceptance process transforms a namespace anchor (including domain namespaces) into a verifiable engineering asset suitable for diligence. A namespace anchor may be represented by a domain name, a DID method namespace, a URI authority, a certificate subject namespace, or another signed scope.

A namespace anchor registry may be hosted under an operator namespace (such as BEIdigest.com) and publishes signed entries mapping each namespace anchor to its authorized resolver parameters and public keys. Each registry entry is content-addressed by anchor_entry_digest and may be included in an append-only registry log to support third-party inclusion proofs.

| | Verifier action (acceptance | |
|---|---|---|
| Step | test) | Evidence objects/outputs |
| 1 | Fetch registry entry for | anchor_entry_digest; |
| | namespace_anchor_id and | publication_signature |
| | verify publisher signature | |
| 2 | Verify inclusion proof (if | registry_proof_digest; |
| | registry log is used) and | prior_registry_hash; |
| | confirm non-downgrade rule | downgrade_indicator |
| 3 | Resolve namespace address | resolver_params_digest; |
| | using declared resolver | resolver_transcript |
| | parameters | |
| 4 | Compute | resolver_transcript_digest |
| | resolver_transcript_digest = | |
| | H(resolver_transcript ∥ | |
| | resolver_params_digest ∥ | |
| | anchor_entry_digest) | |
| 5 | Compute scope_hash = | scope_hash |
| | H(namespace_anchor_value ∥ | |
| | anchor_entry_digest) | |
| 6 | Bind scope_hash and | receipt_record.scope_hash; |
| | resolver_transcript_digest | proof_set.anchors |
| | into receipt_record and | |
| | proof_set | |
| 7 | Acceptance passes if | ACCEPT/REJECT; |
| | recomputation matches and | reason_code |
| | registry entry is current | |
| | within time_hash window | |

In some embodiments, a failure in acceptance emits a closed-set reason_code (such as RC_ANCHOR_UNVERIFIED, RC_REGISTRY_PROOF_INVALID, RC_DOWNGRADE_DETECTED) and persists a receipt record committing to the rejection evidence. This enables independent audit and prevents silent anchor drift.

Worked Example D (namespace Anchor Registry Acceptance Test Vector)

The following test vector illustrates acceptance of a domain namespace anchor using a registry entry and a resolver transcript digest. All values are illustrative. H(⋅) denotes SHA-256 in this example, and concatenation is byte concatenation of UTF-8 strings with ‘|’ separators as shown.

| Item | Illustrative value |
|---|---|
| namespace_anchor_value | atms.com |
| registry host (illustrative) | beidigest.com |
| resolver_pubkey_fp (truncated) | 0f278b190c0bd5b4c0bc3b00d28fb2bf |
| resolver_params_digest (SHA-256) | 60e6186b3d3e3f3e9f7fe2e3241fb971736eab7 |
| | 0723aa2a577a0c724ccfe774b |
| anchor_entry_ascii (canonical) | anchor=atms.com\|registry=beidigest.com\|reso |
| | lver_pubkey_fp=0f278b190c0bd5b4c0bc3b00 |
| | d28fb2bf\|resolver_params_digest=60e6186b3 |
| | d3e3f3e9f7fe2e3241fb971736eab70723aa2a5 |
| | 77a0c724ccfe774b\|valid_from=2026-01- |
| | 01T00:00:00Z\|valid_to=2027-01- |
| | 01T00:00:00Z\|policy_scope=clearing-kernel |
| anchor_entry_digest (SHA-256) | b73c78352d4a8ac8bdc5efc0b8a29ef4d186cbc |
| | a68fe5b4fdfdb1d76ea56438d |
| registry_log_leaf (SHA-256) | 5c5314df2090491578bb6d6b9fea1d6d2c75b9 |
| | 01412e4003fd31fede3d993ef3 |
| registry_proof_digest (SHA-256) | 6d2fb096ec27f95492af430ac39dd23ce5e1980 |
| | 6ff2b961adefeb92d3bf7424f |
| resolver_transcript_ascii (canonical) | query=DNS_TXT_atms.com;response=TXT |
| | “scope=ATMS_ROOT;resolver=OK”;timesta |
| | mp=2026-02-28T12:34:56Z;nonce=00000001 |
| resolver_transcript_digest (SHA-256) | b8ff5e9900efadb285b52ed42c4c4701a2cc265 |
| | fd62ea792c8b037909792673c |
| scope_hash (SHA-256) | 3c5fe76ef509e5ae86d6d6ada9d3fc996224ecb |
| | f7d5180c0371d7c721a43328a |

Acceptance result: the verifier confirms publication_signature over anchor_entry_digest, verifies registry_proof_digest (if used), recomputes resolver_transcript_digest and scope_hash, and binds scope_hash and resolver_transcript_digest into receipt_record and proof_set. A closed-set decision_code=DC_APPROVE with reason_code=RC_OK is emitted upon success; failures emit RC_ANCHOR_UNVERIFIED, RC_REGISTRY_PROOF_INVALID, or RC_DOWNGRADE_DETECTED with a rejection receipt.

### Worked Example E (BEIdigest.com Registry Log Append-Only Chain and Downgrade Detection)

The following example illustrates an append-only registry log hosted under an operator namespace (such as BEIdigest.com). Each registry event appends a new registry block with registry_hash=H(prev_registry_hash∥anchor_entry_digest∥event_type∥time_hash). A verifier rejects non-monotonic or downgraded entries by enforcing that (i) prev_registry_hash links to the prior accepted block, (ii) time_hash is within the acceptance window, and (iii) a downgrade_indicator is absent unless an adjudication receipt authorizes remediation.

| | prev_registry_{—} | | anchor_entry_{—} | | |
|---|---|---|---|---|---|
| Block# | hash | event_type | digest | time_hash | registry_hash |
| 0 | (genesis) | 00000000000 | — | — | — |
| | | 00000000000 | | | |
| | | 0000000000 | | | |
| | | . . . | | | |
| 1 | 00000000000 | ADD | 7b3ac0d7daa | 2026-02- | b42c78253a0 |
| | 00000 . . . | | 21466 . . . | 28T12:00:00Z | dbc87 . . . |
| 2 | b42c78253a0 | ROTATE_KEY | bc3ee7d0632 | 2026-03- | 29d66e5a5ea |
| | dbc87 . . . | | 363f1 . . . | 01T09:00:00Z | 34a85 . . . |
| 3 | 29d66e5a5ea | ADD | 5210c8509ca | 2026-03- | 94ffd30f3d21 |
| | 34a85 . . . | | 58735 . . . | 05T10:30:00Z | 1d7e . . . |

Downgrade detection example: if a presented anchor_entry_digest attempts to revert to an older resolver_params_digest or key fingerprint without an authorized adjudication receipt, the verifier emits reason_code=RC_DOWNGRADE_DETECTED and persists a rejection receipt committing to the offending registry_hash and anchor_entry_digest.

Illustrative domain anchors may include atms.com, bei.app, mf.app, beidid.com, and BEIdigest.com. These examples are illustrative and non-exclusive and do not limit claim scope.

### VIII. CANONICALIZATION PROFILE AND CANONICAL INTENT ENVELOPE

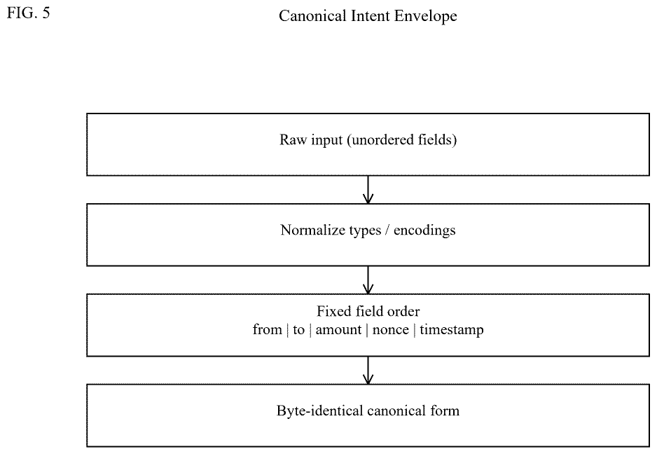

Canonicalization profile (FIG. 5). The canonicalization profile defines type normalization rules and a fixed field ordering. A ordering is from|to|amount|nonce|timestamp as used in dependent claims.

Type normalization. Type normalization includes coercing amount and nonce to integer types, coercing timestamp to a fixed second-level granularity, and enforcing canonical string encodings for identifiers.

Required/extra fields. In some embodiments, the canonicalization profile engine rejects missing required fields and rejects extra fields, ensuring that semantically distinct intents cannot be made to collide by omission or injection.

Byte-identical encoding. The canonicalization profile engine serializes ordered fields into a delimiter-separated byte string or structured binary encoding. The encoding procedure is deterministic and reproduces identical bytes for identical inputs.

Canonical_profile_id binding. The canonical_profile_id is stored in the receipt record and/or proof set so that third parties can identify which canonicalization profile was used.

Example canonicalization_profile: -required_fields: [from, to, amount, nonce, timestamp]-field_order: from|to|amount|nonce|timestamp-type rules: from: utf8_string to: utf8_string amount: int64 nonce: uint64 timestamp: unix_seconds_uint64-delimiter: “|”-normalization: identifiers: lower_case_ascii; trim_whitespace timestamp: floor_to_seconds

### IX. CRYPTOGRAPHIC VERIFICATION

Transaction hash. The cryptographic verification engine computes tx_hash by hashing the canonical intent envelope using a hash function designated by hash_function_id. hash functions include SHA-256 and Keccak-256.

Signature verification. The engine verifies a digital signature over tx_hash using a public key stored in the sender account container. signature algorithms include elliptic-curve signatures over secp256k1.

Determinism predicate. The verification step is deterministic because both tx_hash and the signature verification inputs are derived from the byte-identical canonical intent envelope and the sender public key field.

### X. NONCE GATE, IDEMPOTENCY, AND DETERMINISTIC ERROR PATHS

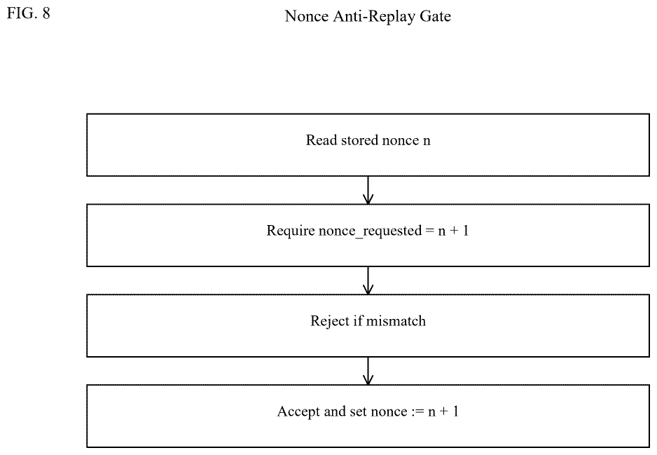

Nonce gate (FIG. 8). The nonce gate admits execution only when nonce_requested==nonce_stored+1. Requests having nonce less than or equal to nonce_stored are rejected as replays.

Idempotency. In some embodiments, tx_hash is treated as an idempotency key such that resubmission of an already-committed tx_hash does not re-apply balance changes. The receipt record may be returned for repeated submissions.

Deterministic error paths. The system emits deterministic status codes for invalid signature, nonce violation, insufficient balance, malformed envelope, and policy rejection. Deterministic error paths prevent ambiguous partial execution and improve auditability.

Error code binding. In some embodiments, status_code and error_detail are included in the receipt record and are incorporated into the ledger block metadata such that the proof set reflects both success and failure outcomes.

status_code table (illustrative; closed-set, schema-versioned). One schema uses symbolic tokens: OK, SIG_INVALID, NONCE_INVALID, BALANCE_INSUFFICIENT, ENVELOPE_INVALID, POLICY_REJECTED. Another schema uses compact codes (see Annex A.1/A.5): OK_00, ERR_02, ERR_03, ERR_04, ERR_06, ERR_10. In such case, symbolic tokens are treated as aliases under a declared status_code_schema_id.

### XI. DETERMINISTIC EXECUTION

Atomic update. Upon successful verification and nonce gating, the deterministic execution engine updates balances of a sender account container and a receiver account container in an atomic operation, and emits a receipt record.

Receipt contents. A receipt record comprises tx_hash, pre-balance value, post-balance value, status_code, and a policy-version identifier. The receipt record may additionally include mapping_version and rail digests when legacy rails are used.

Storage backends. In some embodiments, the account container store is implemented using a relational database, a key-value store, or an authenticated data structure. Regardless of storage backend, the deterministic boundary remains at canonicalization and receipt record emission.

### XII. APPEND-ONLY VERIFIABLE LEDGER

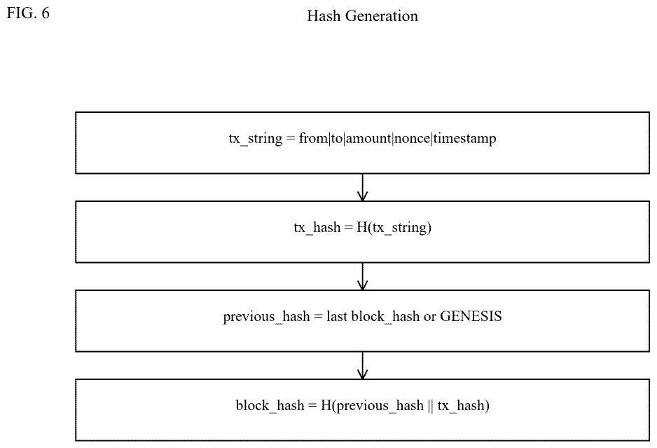

Ledger engine (FIG. 6). The append-only verifiable ledger engine computes block_hash by hashing a byte-concatenation of previous_hash and tx_hash and appends a ledger block comprising at least previous_hash, tx_hash, and block_hash.

No consensus requirement. The ledger is append-only and verifiable without executing a distributed consensus protocol and without mining. Ordering is established by the insertion order of the ledger engine.

Relational storage. In some embodiments, ledger blocks are stored in a relational database while preserving insertion order. A monotonic sequence number may be stored alongside each ledger block.

Genesis. The first block may use a GENESIS previous_hash constant. Thereafter, previous_hash equals the prior block_hash.

Audit linkability. Because block_hash binds previous_hash and tx_hash, any modification to prior entries changes all subsequent block_hash values, enabling tamper-evident audit trails.

### XIII. VERIFICATION INTERFACE AND PROOF SET

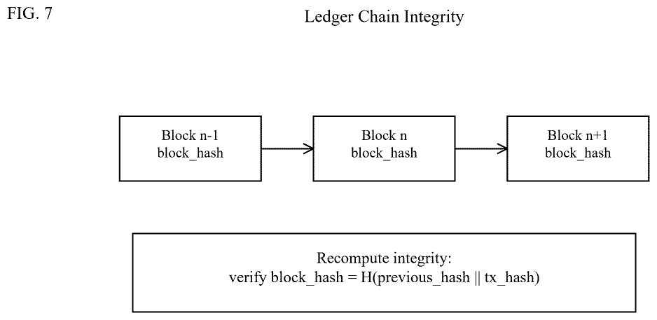

Verification interface (FIG. 7). The verification interface returns, for a requested tx_hash, a proof set comprising at least previous_hash, block_hash, hash_function_id, and canonical_profile_id.

Third-party recomputation. An independent verifier recomputes H(byte-concatenation of previous_hash and tx_hash) using hash_function_id and checks equality to block_hash, and independently reconstructs canonical intent envelope using canonicalization profile identified by canonical_profile_id.

Proof portability. The proof set is portable across implementations because it is defined in terms of locked tokens and deterministic recomputation procedures.

Batch proofs. In some embodiments, the verification interface supports batch queries and returns Merkle-like aggregates; however, the minimal proof set remains available for point proofs.

### XIV. LEGACY RAIL ADAPTER AND TWO-PHASE BRIDGING

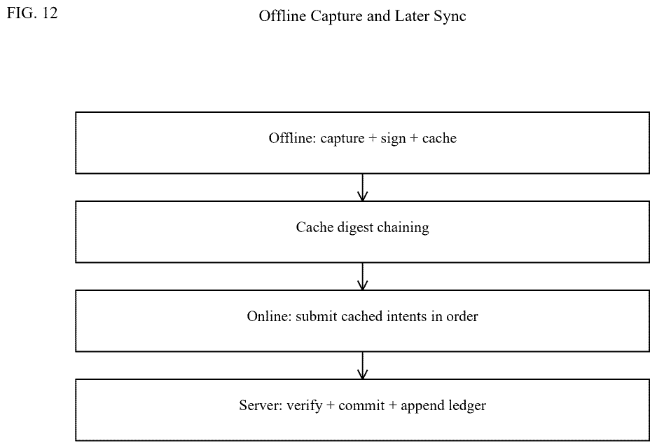

Legacy rail adapter (FIG. 12). The legacy rail adapter deterministically maps a namespace address to a legacy rail endpoint using mapping_version and constructs a rail payload from normalized canonical fields.

Rail payload digest. The adapter computes rail_payload_digest as a cryptographic digest of the rail-specific payload bytes derived from canonical intent envelope, binding the exact bytes transmitted to the legacy rail.

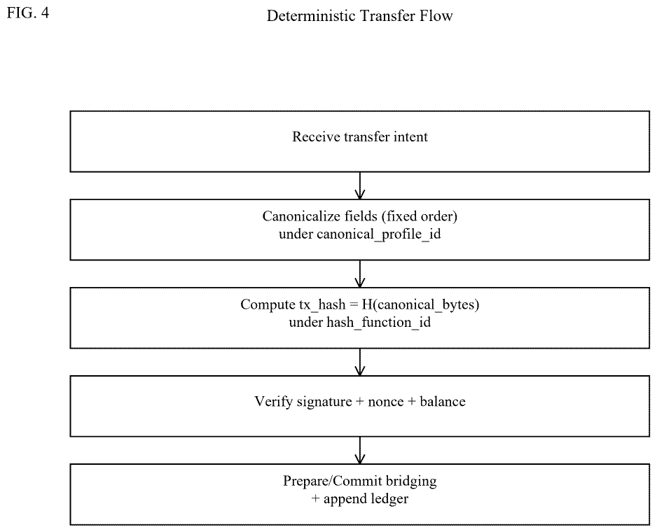

Two-phase bridging (FIG. 4). A prepare phase generates a provisional receipt including rail_payload_digest prior to transmission, and a commit phase receives an acknowledgement, computes rail_ack_digest as a cryptographic digest of acknowledgement fields, and binds rail_ack_digest to the receipt record and/or to the append-only verifiable ledger.

Deterministic mapping rules. mapping_version identifies a deterministic mapping rule set including field selection, normalization rules, endpoint selection, and encoding rules. Changing mapping_version changes derived payload bytes and therefore changes rail_payload_digest.

Reconciliation. By storing mapping_version, rail_payload_digest, and rail_ack_digest, the system supports reconciliation between domain-anchored intents and legacy rail outcomes without relying on proprietary reconciliation identifiers. two-phase bridging sequence: 1) PREPARE:-derive rail_payload_bytes=Map(mapping_version, canonical_intent_envelope)-rail_payload_digest=H(rail_payload_bytes)-emit provisional receipt_record including rail_payload_digest 2) COMMIT:-send rail_payload_bytes to legacy rail endpoint-receive acknowledgement bytes-rail_ack_digest=H(acknowledgement_bytes)-bind rail_ack_digest to receipt_record and/or ledger block

### XV. TERMINAL DEVICE, OFFLINE CAPTURE, AND SYNCHRONIZATION

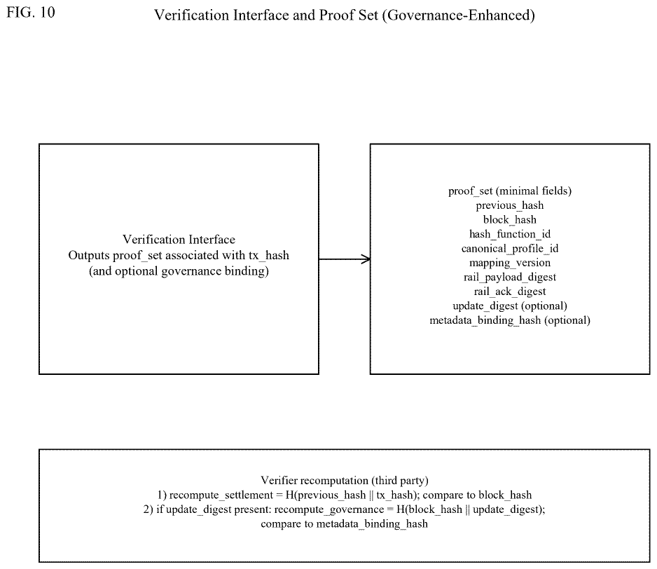

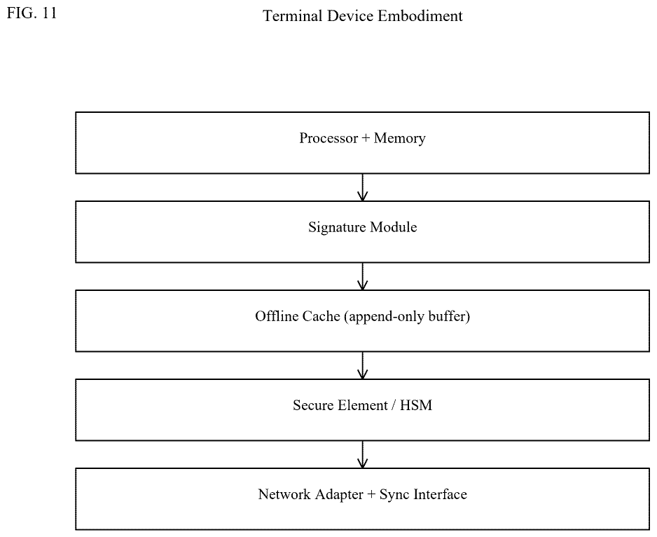

Terminal device (claim 3; FIGS. 10-11). A terminal device comprises a signature module configured to produce a digital signature over a tx_hash of a canonical intent envelope, an offline cache configured as an append-only buffer storing cached receipt records, and a network interface for later synchronization.

Offline hash chaining. In one embodiment, the offline cache stores a cached receipt digest as H(previous_cached_digest∥current_receipt_digest), yielding tamper-evident offline logs.

Secure element. In some embodiments, a secure element protects a device private key used by the signature module. The device may also store a device certificate for attestation to a server. Ordered synchronization. Upon restoration of connectivity, cached intents are transmitted in order, enabling server-side nonce gate verification and deterministic ledger commitment. Conflict handling. If a cached intent fails verification (such as nonce conflict), the deterministic error path emits a receipt record with a failure status_code and preserves the offline chain for audit.

### XV.A Offline Receipt Chaining and Mainnet Synchronization Conflict Resolution

In some embodiments, offline operation uses an offline_pre_authorization_token bound to namespace address, snapshot_id, credit_limit, expiry, and nonce bounds. A terminal device emits an offline receipt chain where each offline_receipt_hash commits to (i) canonical_intent_digest, (ii) token_id and token digest, (iii) observed nonce material, and (iv) a prior_offline_receipt_hash. Upon reconnection, the terminal submits receipts in chain order and the mainnet verifier rejects gaps, replays, and out-of-window tokens in a fail-closed manner.

| Condition | Mainnet rule (deterministic) | Outcome/evidence |
|---|---|---|
| Token expired (time_hash | Reject before atomic | Receipt commits expiry |
| outside expiry) | boundary; emit | check and reason_code |
| | ERR_TTL_EXPIRED | |
| Nonce replay or gap | Reject; emit | Receipt chain preserves |
| | RC_NONCE_REPLAY; | prior_receipt_hash to prevent |
| | require fresh token or | suppression |
| | recovery procedure | |
| Concurrent spend detected | Emit DC_CONFLICT; | Conflict receipt commits |
| | produce conflict marker and | competing tx_hash values |
| | bounded retry window | |
| Offline batch partial | Accept prefix of chain until | Acceptance receipts reference |
| acceptance | first invalid receipt; reject | last accepted |
| | remainder | offline_receipt_hash |
| Rail ack mismatch post-sync | Emit | Receipt binds rail_ack_digest |
| | RC_RAIL_ACK_MISMATCH; | and mapping_version |
| | require rail evidence | |
| | replay under | |
| | mapping_version | |

In some embodiments, mainnet synchronization emits a FinalityMarker for each accepted receipt and a ConflictMarker for rejected competing receipts, enabling audit replay and dispute review without reprocessing internal state.

### XVI. SECURITY, POLICY, AND COMPLIANCE EXTENSIONS

Policy-version identifier. Receipt records may include a policy-version identifier to bind execution to a specific policy configuration, enabling deterministic compliance and reproducible audits.

Risk gating. In some embodiments, an external risk oracle computes a risk score and the nonce gate or execution engine enforces thresholds deterministically; the risk score and threshold decision can be recorded in receipt record metadata.

Privacy. The canonical intent envelope may include pseudonymous identifiers; a separate disclosure mechanism may be used for authorized tracing without changing deterministic core fields.

Rate limits and scarcity. The system may enforce deterministic per-namespace or per-account limits (such as maximum amount per interval) and record limit evaluations in receipt records. Interoperability. The legacy rail adapter may support multiple rails (such as ACH, RTP, FedNow) using mapping_version to select rail-specific mapping rules.

### XVI.A Deterministic 32-Dimensional Behavioral Risk Vector and AML Trigger Logic

In some embodiments, evaluating risk constraints comprises computing a deterministic 32-dimensional behavioral risk vector under a policy snapshot. Each dimension dim_i is computed as a pure function of declared evidence objects (such as receipt chain, account container state digests, rail evidence digests, and policy snapshot parameters), such that an independent verifier can reproduce the same vector and RiskScore given the same inputs and policy_version_id.

| | | Deterministic computation |
|---|---|---|
| Dimension | Feature name | (illustrative) |
| dim_01 | KYC_tier_level | Encoded verification tier of |
| | | the account container (such as |
| | | 0 . . . 3) |
| dim_02 | account_age_bucket | Deterministic bucket from |
| | | first_seen_time_hash |
| dim_03 | txn_velocity_1 h | Count of intents in last 1 h |
| | | window (receipt_chain) |
| dim_04 | txn_velocity_24 h | Count of intents in last 24 h |
| | | window |
| dim_05 | amount_zscore_bucket | Bucketed deviation from |
| | | rolling median under |
| | | snapshot window |
| dim_06 | counterparty_risk_class | Deterministic class of |
| | | counterparty scope_hash |
| dim_07 | cross_border_flag | 1 if jurisdictions differ; else 0 |
| | | (jurisdiction_code_set) |
| dim_08 | sanctions_list_hit | 1 if match in published |
| | | sanctions digest set; else 0 |
| dim_09 | pep_flag | 1 if PEP digest match; else 0 |
| dim_10 | device_binding_mismatch | 1 if terminal/device |
| | | attestation digest mismatches; |
| | | else 0 |
| dim_11 | geo_distance_bucket | Bucketed distance between |
| | | successive verified locations |
| dim_12 | time_of_day_bucket | Bucket under |
| | | local_time_hash rules |
| dim_13 | rail_family_risk_weight | Weight by rail_family_id |
| | | under policy snapshot |
| dim_14 | mapping_version_delta | 1 if mapping_version |
| | | changed within window; else |
| | | 0 |
| dim_15 | ack_schema_incompatibility | 1 if ack_schema_id violates |
| | | presence_rule_id; else 0 |
| dim_16 | ack_mismatch_rate | Rate of rail_ack mismatches |
| | | in window |
| dim_17 | chargeback_ratio_bucket | Bucketed ratio of |
| | | disputed/failed receipts |
| dim_18 | nonce_anomaly_flag | 1 if nonce gaps/replays |
| | | exceed bounds; else 0 |
| dim_19 | policy_override_depth | Depth of inheritance |
| | | overrides on selected node |
| | | path |
| dim_20 | graph_settlement_{—} | Sparse-matrix nnz count |
| | complexity | bucket for settlement matrix |
| dim_21 | balance_drain_rate | Outflow/inflow ratio bucket |
| | | over window |
| dim_22 | new_payee_flag | 1 if counterparty first_seen |
| | | within window; else 0 |
| dim_23 | structuring_pattern_score | Deterministic score for |
| | | split-amount patterns |
| dim_24 | round_amount_flag | 1 if amount_minor ends with |
| | | policy-defined pattern |
| dim_25 | rapid_hop_flag | 1 if multi-hop chain detected |
| | | within N steps |
| dim_26 | beneficiary_concentration | Bucketed concentration |
| | | across counterparties |
| dim_27 | industry_profile_mismatch | 1 if industry_id conflicts with |
| | | route profile; else 0 |
| dim_28 | evidence_gap_flag | 1 if required evidence_digest |
| | | missing; else 0 |
| dim_29 | credit_limit_utilization | Utilization ratio of |
| | | credit_limit/available |
| dim_30 | ttl_margin | Remaining TTL bucket of |
| | | routing key |
| dim_31 | offline_token_usage_flag | 1 if offline_pre_{—} |
| | | authorization_token |
| | | used; else 0 |
| dim_32 | quorum_override_flag | 1 if adjudication/quorum |
| | | digest present; else 0 |

In some embodiments, RiskScore is computed as RiskScore=Σ_i w_i·dim_i with weights w_i bound by policy_version_id and snapshot_id. An AML trigger fires when RiskScore exceeds a threshold or when any hard constraint predicate evaluates TRUE (such as sanctions_list_hit=1). The deterministic risk finite-state machine emits a reason_code (such as RC_RISK_BLOCK) and persists a receipt committing to the vector digest and decision.

### XVII. DOMAIN-ANCHORED FINANCIAL ROUTING EXTENSIONS (BEIRouting CONTEXT)

Routing replacement context. In some embodiments, the domain namespace corresponds to an institution or routing scope. A namespace address thereby functions as a human-readable routing destination, reducing input errors associated with numeric routing identifiers.

Routing rule store. A routing_rule_store (example: routings.app) may publish deterministic mapping_version sets for a given domain namespace, enabling consistent mapping across clients.

Routing gateway. A routing gateway (example: example-routing-gateway) may expose a deterministic API returning mapping_version and endpoint selection outputs that can be recomputed by third parties when the same rule set is used.

Bank integration. For a bank deployment, the legacy rail adapter may map namespace address to bank-specific account formats while still binding rail_payload_digest and rail_ack_digest for evidence-grade reconciliation.

### XVII.A Illustrative Domain-Anchor Deployment Examples (Non-Exclusive)

In some embodiments, a domain namespace is used as an illustrative namespace anchor for deployment, branding, and operator scoping. The following domain examples are illustrative and non-exclusive; they describe one possible namespace partitioning and do not limit the claims. A verifier and the kernel operate on the namespace anchor value (scope_hash) and are not limited to DNS.

| Domain (illustrative) | Role/usage example |
|---|---|
| atms.com | Primary operator namespace; clearing kernel |
| | root anchor for payment addressing and |
| | proof-set verification. |
| bei.app | Identity-facing gateway; namespace anchor |
| | for account containers and policy scopes. |
| mf.app | Mobile/field terminal namespace; offline |
| | capture and synchronization endpoints. |
| beieco.com | Economic policy namespace; policy_version |
| | and conformance publication scope. |
| beidid.com | DID/identity namespace; account container |
| | binding and resolver transcript anchoring. |
| beieid.com | EID namespace; identity evidence digest |
| | registry anchor. |
| dridx.com | DRID/role attestations namespace for KYC |
| | tier and verification tiers. |
| beitoken.com | Tokenization namespace; issuance receipts |
| | bound to proof objects. |
| beinft.com | NFT evidence object namespace; provenance |
| | receipts and registry proofs. |
| beifr2.com | Bounded remediation (FR2) namespace; |
| | adjudication receipts and blast-radius bounds. |
| beiclawback.com | Clawback/dispute namespace; dispute review |
| | and recovery receipts. |
| beisign.com | Signature/attestation namespace; role |
| | attestations and signing policy. |
| beicurrency.com | Currency namespace; settlement class |
| | identifiers and reserve links. |
| timecurrency.com | Time-based unit namespace; time_hash |
| | windows and time-valued assets. |
| beigx.com | Exchange gateway namespace; |
| | interoperability endpoints. |
| beicx.com | Clearing exchange namespace; mapping |
| | profiles and rail adapters. |
| beisx.com | Settlement exchange namespace; settlement |
| | matrix profile publication. |
| beiindex.com | Index/benchmark namespace; reference data |
| | and pricing digests. |

### XVIII. HARDWARE-VERIFIED MINTING AND TIME-VALUED ASSET EXTENSIONS (ATMS CONTEXT)

Hardware-verified capture. The terminal device of claim 3 may be implemented as a physical ATM-class terminal. The terminal may capture a verified event (such as proof of presence, proof of service) and bind the event to a canonical intent envelope.

Time-valued assets. In some embodiments, the system mints a time-valued unit responsive to a verified event and clears that unit using the deterministic clearing kernel. The minting procedure can be logged as receipt records and ledger blocks for third-party recomputation.

Separation of concerns. The deterministic clearing kernel remains the proof-carrying settlement core; time-valued minting and domain-as-account abstractions are layered above it and may be claimed in related continuations or companion filings.

### XIX. EXEMPLARY EMBODIMENTS

### Embodiment 1

Embodiment 1 provides an implementation variant of the deterministic clearing kernel in which the canonicalization profile is versioned by canonical_profile_id “P01” and the hash function designated by hash_function_id is configured per deployment constraints.

In this embodiment, the namespace address resolver accepts both namespace/account_id and account_id@namespace syntaxes and deterministically normalizes inputs prior to address_hash computation.

The canonicalization profile engine enforces the fixed field ordering from|to|amount|nonce|timestamp, coerces timestamp to seconds, and rejects any extra field not in the required_fields list.

The cryptographic verification engine verifies a signature over tx_hash using the public key field in the sender account container; failures follow deterministic error paths and emit receipt records with status_code SIG_INVALID.

The nonce gate enforces nonce_requested==nonce_stored+1 and rejects replay; if offline capture is used, the terminal device provides cached receipt records that are hash-chained prior to synchronization.

When legacy rails are enabled, mapping_version “M{e:02d}” selects a deterministic mapping rule set and the legacy rail adapter binds rail_payload_digest (prepare) and rail_ack_digest (commit) into receipt records.

The verification interface returns a proof set sufficient for third-party recomputation of block_hash, including previous_hash, tx_hash, block_hash, hash_function_id, and canonical_profile_id.

Embodiment 1 processing flow: 1) Parse namespace address->(domain namespace, account identifier) 2) Resolve account container(s) 3) Canonicalize->canonical intent envelope (profile P01) 4) tx_hash=H(envelope); verify signature 5) nonce gate; deterministic execution; emit receipt record 6) block_hash is computed by hashing a byte-concatenation of previous_hash and tx_hash; append ledger block 7) Selectively included: legacy rail adapter (mapping_version M01) prepare/commit with rail digests

### XX. EXAMPLES

Example 1 (Signature-invalid). A transfer request is received with a malformed signature. The system canonicalizes fields, computes tx_hash, fails signature verification, emits receipt record status_code SIG_INVALID, and does not update balances.

Example 2 (Nonce replay). A request repeats a prior nonce value. The nonce gate rejects it deterministically and emits receipt record status_code NONCE_INVALID.

Example 3 (Legacy rail bridging). A request is prepared for a rail endpoint under mapping_version. rail_payload_digest is computed and stored. Upon acknowledgement, rail_ack_digest is computed and bound to the ledger, enabling independent reconciliation.

Example 4 (Offline terminal sync). A terminal device caches three intents offline, hash-chains cached receipt digests, then synchronizes. The server verifies nonce ordering and commits ledger entries in order, returning proof sets for each tx_hash.

### Worked Example A (Deterministic Canonicalization and Two-Phase Rail Evidence)

A transfer intent is evaluated under canonical_profile_id=CP_01 and hash_function_id=HF_SHA256. A canonical intent envelope is constructed as the following byte-identical serialization:
from=acct_A01|to=acct_B01|amount_minor=10037|currency=USDT|nonce=1|timestamp_s=173 0000060

The resulting tx_hash (SHA-256) is 9de6c6a54b08f4c5c5ab05bdd11f9a5f5487c650ae3e9ca60dad287fe7b54366. A legacy rail adapter generates rail_payload_digest=f8567719bff6fcac93baa6b8a460d3bee5def21739c35c542ae04749976c24c9 and rail_ack_digest=8d3950f1b4531c8a2fbf82bcfea4a0afa91df72c2e46fae74df371797445fb51. The receipt record binds mapping_version=MV 01, ack_schema_id=ACKS_01, presence_rule_id=PR_00, and ack_status_code=OK_00. A verification interface returns a proof set containing tx_hash, canonical_profile_id, hash_function_id, mapping_version, rail_payload_digest, and rail_ack_digest, enabling independent third-party recomputation and replay audit.

### Worked Example B (Fail-Closed Nonce Replay and Evidence-Carried Reason Code)

A request repeats a previously accepted nonce value for the same account node. The nonce gate rejects the request prior to the atomic commit boundary. The system emits a denial decision_code and a replay reason_code, and persists a receipt record that commits to the evaluated constraint, the observed nonce material, and the rejection outcome. The receipt record is chained to the prior receipt_hash to prevent suppression, and the verifier recomputes the decision and reason code from the same snapshot_id, canonical_profile_id, and declared nonce-gate rule.

### Closed-Set Tables (Decision Codes, Reason Codes, Error Codes)

In some embodiments, decision codes, reason codes, and error codes are drawn from a closed set to improve determinism and auditability. The following tables are illustrative; implementations may extend codes while preserving deterministic mapping and version binding.

| decision_code | Meaning | Verifier check |
|---|---|---|
| DC_APPROVE | Execution permitted; atomic | post_state_digest and |
| | commit performed | finality_marker consistent |
| | | with inputs |
| DC_DENY | Execution blocked prior to | receipt contains constraint |
| | commit | digest and denial reason_code |
| DC_DEFER | Execution deferred (such as | receipt indicates pending state |
| | pending rail ack) | and required follow-up |
| | | evidence |
| DC_CONFLICT | Conflict detected (such as | receipt indicates conflict |
| | concurrent access) | marker and retry bounds |
| reason_code | Meaning (illustrative) | |
| RC_OK | All constraints satisfied | |
| RC_NONCE_REPLAY | Nonce gate detected replay or | |
| | out-of-order nonce | |
| RC_TTL_EXPIRED | Routing key time-to-live | |
| | expired | |
| RC_POLICY_MISMATCH | snapshot_id or policy_version | |
| | mismatch | |
| RC_RAIL_ACK_MISMATCH | rail_ack_digest does not | |
| | validate against rail response | |
| | under mapping_version | |
| RC_RISK_BLOCK | Risk FSM blocked execution | |
| | under policy snapshot | |
| | constraints | |
| error_code | Meaning (illustrative) | |
| ERR_SIG_INVALID | Signature invalid for tx_hash | |
| | under account container | |
| | public key | |
| ERR_CANON_PROFILE_{—} | canonical_profile_id | |
| UNKNOWN | unknown or not permitted by | |
| | policy scope | |
| ERR_MAPPING_VERSION_{—} | mapping_version unknown or | |
| UNKNOWN | not permitted for | |
| | rail_family_id | |
| ERR_INVARIANT_{—} | Deterministic invariant | |
| VIOLATION | violated; fail-closed | |

Worked Example C (AML Trigger with Evidence-Carried Decision)

A transfer intent is evaluated under snapshot_id binding policy_version_id and time window. The system computes the deterministic 32-dimensional risk vector and a RiskScore under the policy weights. Suppose sanctions_list_hit=1 (dim_08=1) and RiskScore exceeds the policy threshold. The risk finite-state machine gates execution prior to the atomic commit boundary and emits decision_code=DC_DENY and reason_code=RC_RISK_BLOCK. A receipt record is persisted committing to: (i) canonical_intent_digest and tx_hash, (ii) snapshot_id and policy_version_id, (iii) risk_vector_digest and RiskScore, (iv) the hard constraint predicate that fired, and (v) denial outcome. The verification interface returns a proof set that enables an independent verifier to recompute the risk_vector_digest and confirm that the denial was deterministically required by the published policy snapshot.

| Field committed in | |
|---|---|
| receipt_record | Illustrative value/rule |
| decision_code | DC_DENY |
| reason_code | RC_RISK_BLOCK |
| risk_vector_digest | H(dim_01∥ . . . ∥dim_32) under |
| | hash_function_id |
| RiskScore | Σ_i w_i•dim_i under policy snapshot |
| hard_predicate | sanctions_list_hit == 1 OR RiskScore >= |
| | threshold |
| policy_snapshot_digest | H(snapshot_id ∥ policy_version_id ∥ |
| | time_window ∥ params_digest) |

### XXI. PRIOR ART DEFICIENCY MATRIX (; SUPPORT FOR NOVEL COMBINATION)

matrix entries comparing technical deficiencies of representative systems with the disclosed deterministic kernel combination.

ANNEX A - Diligence & Enterprise Kernel Extensions

| | | | Addressed by this |
|---|---|---|---|
| | Representative | Technical deficiency | disclosure |
| Category | systems (illustrative) | (illustrative) | (illustrative) |
| Numeric routing + | ACH/wire/SWIFT | Static numeric | Human-readable |
| account | | routing codes are | namespace |
| | | non-intuitive and | addressing with |
| | | error-prone; no | verifiable resolver |
| | | deterministic | evidence; byte- |
| | | canonical intent | identical |
| | | envelope; no portable | canonicalization |
| | | proof_set | under |
| | | recomputation; | canonical_profile_id; |
| | | reconciliation | proof_set returns |
| | | depends on | tx_hash + anchors for |
| | | proprietary | third-party |
| | | identifiers; | recomputation; two- |
| | | routing/mapping/policy | phase rail evidence |
| | | updates may occur | binding |
| | | off-ledger without | (mapping_version + |
| | | cryptographic | rail_payload_digest + |
| | | binding to committed | rail_ack_digest); |
| | | evidence | governance-to-ledger |
| | | | binding |
| | | | (update_digest, |
| | | | metadata_binding_hash) |
| Alias mapping | Email/phone alias | Directory mappings | Versioned |
| | directories | are provider- | resolver/directory |
| | | managed; lack nonce | evidence; nonce gate + |
| | | gate and evidence | deterministic error |
| | | objects for audit | receipts; audit replay |
| | | replay | via |
| | | | receipt_record/proof_{—} |
| | | | set |
| Consensus-based | Consensus | Requires distributed | Append-only |
| DLT | blockchains | consensus/mining; | verifiable ledger |
| | | higher complexity; | without consensus; |
| | | governance updates | governance-to-ledger |
| | | often off-ledger | binding via |
| | | | update_digest + |
| | | | metadata_binding_hash |
| Name resolution | Name services | Resolve names but | Two-phase rail |
| systems | | do not bind | evidence binding: |
| | | rail_payload_digest/ | mapping_version + |
| | | rail_ack_digest in a | rail_payload_digest + |
| | | two-phase bridging | rail_ack_digest |
| | | sequence | committed into |
| | | | receipt_record/ledger |
| Kiosk/terminal | ATMs/kiosks | Provide buy/sell | Terminal-assisted |
| products | | workflow but not a | capture integrates |
| | | deterministic clearing | with canonicalization + |
| | | kernel with | nonce gate + |
| | | recomputable proof | proof_set |
| | | sets and audit replay | verification; offline |
| | | | hash chaining and |
| | | | deterministic sync |

### A.9 Conformance Record Schema and Publication

In some embodiments, a conformance_record is published to support licensing and verifier interoperability. The conformance_record binds a kernel profile to mapping digests and test vectors, enabling any verifier implementation to validate proof sets and rail evidence digests against published conformance data.

| conformance_record | |
|---|---|
| field | Definition |
| Field | Meaning (illustrative) |
| std_profile_id | Identifier of published conformance profile |
| std_version | Version of published profile |
| canonical_profile_id | Canonicalization profile required for |
| | conformance |
| hash_function_id | Hash function identifier |
| mapping_digest | Digest of mapping rules for mapping_{—} |
| | version family |
| ack_schema_id | Ack schema identifier |
| presence_rule_id | Presence/validation rule identifier |
| test_vector_digest | Digest over published test vectors set |
| publication_signature | Publisher signature over the |
| | conformance_record |
| registry_proof_digest | Digest proving inclusion in a published |
| | registry/log |

### A.10 Non-Financial Domain Applications and Industry Profiles

In some embodiments, the deterministic canonicalization clearing kernel is applied to non-financial domains where audit-grade replay and evidence binding are required. The same receipt_record, proof_set, and mapping/version evidence may bind domain events to an append-only verifiable ledger for independent recomputation and dispute review. Such domains include supply chain provenance, regulated data exchange, infrastructure control governance, and energy dispatch scheduling.

| | Event mapped to | |
|---|---|---|
| Domain | canonical intent | Evidence binding objective |
| Supply chain | shipment_event, | Prove provenance chain and |
| provenance | custody_transfer, | detect post-hoc mutation |
| | inspection_result | |
| Power grid/ | dispatch_instruction, | Prove command/ack integrity |
| energy dispatch | telemetry_commit, | and replay audit of schedule |
| | control_ack | decisions |
| Healthcare | consent_grant, | Prove access compliance and |
| data exchange | access_event, | dispute-resolvable audit |
| | record_hash_commit | |
| IoT device | firmware_update, | Bind governance updates to |
| governance | attestation_report, | verifiable logs and validate |
| | policy_change | rollouts |

### A.0 Purpose and Integration Notes

This Annex replaces repetitive implementation-note pages in the filing package with examiner-ready, diligence-ready technical material integrating: (i) DNH-FRK enterprise kernel concepts (policy snapshots, machine routing keys, deterministic risk FSM gating, atomic commit, settlement matrix), and (ii) governance-to-ledger binding (update_digest, metadata_binding_hash) under the Terminology-Locked core Specification/Claims/Drawings.

All content herein is. The claimed invention remains defined by the Claims section. This Annex strengthens 35 U.S.C. § 112 enablement, provides concrete implementation parameters, and improves diligence/licensing readiness without narrowing claim scope.
No domain brand names are required; any domain-like namespace or equivalent signed configuration substrate may be used.
Governance binding is evidence-grade: verifiers recompute both settlement integrity (block_hash) and governance-state integrity (metadata_binding_hash).
Conformance artifacts (profiles, test vectors, receipt verifier) support licensing and third-party audit without becoming claim-limiting.

Mapping note: policy snapshots and routing keys may be implemented using locked tokens (policy-version identifier, mapping_version, canonical_profile_id) with additional versioned metadata fields.

### A.1 Examiner-Ready Technical Improvement (35 U.S.C. § 101)

Concrete improvements are directed to computer functionality, not mere financial or organizational ideas. The kernel defines a deterministic boundary at the canonical_intent_envelope, and attaches verifiable evidence to each transaction attempt via receipt_record, append-only verifiable ledger chaining, and proof_set.

The following improvements are technical:
Deterministic canonicalization_profile_engine prevents digest divergence across clients by enforcing byte-identical encoding under canonical_profile_id.
nonce_gate+idempotency semantics support safe retries under network reordering without double execution.
legacy rail adapter two-phase bridging binds rail_payload_digest and rail_ack_digest to evidence objects, improving reconciliation between heterogeneous rails.
Governance-to-ledger binding (update_digest, metadata_binding_hash) makes rule evolution independently verifiable, preventing off-ledger relocation of governance.
Concurrency control and atomic_commit_boundary semantics avoid partial state visibility and provide deterministic failure receipts (ERR_*).

Industrial applicability: enterprise settlement, audit-ready clearing, terminal-assisted workflows, and multi-rail reconciliation. These improvements operate at data structure, encoding, state transition, and commit semantics layers.
verification predicate (settlement+governance): recompute_settlement=H(byte-concatenation of previous_hash and tx_hash) recompute_governance=H(byte-concatenation of block_hash and update_digest) valid=(recompute_settlement==block_hash) && (recompute_governance==metadata_binding_hash if present)

### A.2 Enterprise Namespace->Hierarchical Account Graph (DNH-FRK Compatibility)

In selectively included enterprise embodiments, namespace_address strings are interpreted as hierarchical paths. A canonical path derivation yields a deterministic hierarchical account graph (parent/child account nodes). This supports enterprise structures such as region/store/agent/device while preserving locked tokens domain_namespace, account_identifier, and account_container.

path derivation examples: Format 1: <namespace>/<account_id>/<sub_id1>/<sub_id2>Format 2: <sub_id2>.<sub_id1>.<account_id>@<namespace>Canonical rule: lower-case, NFC normalize, reject control chars; then compute node_path[ ]

Each node_path component deterministically resolves to an account_container representing a scoped account state (public_key_field, balance_field, nonce_field) plus policy metadata.

### A.2.1 Deterministic Inheritance for Parameters

An inheritance rule engine computes an effective_parameter_set for a selected account node by applying a deterministic override precedence table across ancestors (such as parent-default<role override<node override<emergency override). This enables policy-based limits, thresholds, settlement allocations, and compliance rules to be inherited deterministically.

Pseudocode: params=inherit_from_ancestors(node_path) params=apply_role_overrides(params) params=apply_node_overrides(params) params_digest=H(serialize(params))//bind params_digest into policy-version identifier metadata or snapshot_id (see A.3)

Inheritance computation is compatible with the locked token policy-version identifier by binding the resolved effective parameters to a specific policy version and effective window.

### A.2.2 Settlement Matrix on Graph Edges

A settlement matrix may be bound to hierarchical edges or node tiers to deterministically allocate value between child and parent nodes. This supports enterprise fee splits, treasury allocations, and reconciliation without compromising the deterministic kernel boundary.

Example settlement matrix row: edge: child_node->parent_node allocation: child=97%; parent_fee=3% applied at commit: allocations recorded in reconciliation_marker metadata When multi-rail reconciliation is used, finality_marker/state_digest/reconciliation_marker/rollback_proof may be recorded as shown in Annex A Enhanced and in the TERMINOLOGY AND DEFINITIONS.

A.3 Versioned Policy Snapshots with Effective Time Windows

In selectively included embodiments, a policy snapshot binds: (i) a policy_version_id, (ii) an effective time window, and (iii) a digest of applicable parameters to prevent configuration drift across caches. This corresponds to snapshot-bound evaluation in enterprise kernels such as DNH-FRK, and can be implemented using locked tokens (policy-version identifier, mapping_version, canonical_profile_id) plus window and digest fields in receipt_record metadata.

snapshot_id construction: snapshot_id=H(policy_version_id∥effective_start_s∥effective_end_s∥params_digest∥cache_token)//cache_token is selectively included; params_digest derived from deterministic inheritance

A verifier can check that a receipt_record references a stable snapshot_id (or equivalent bound fields) for the full transaction lifecycle including retries.

### A.3.1 Unified Payment Routing Key (UPRK) as Machine Routing Key

A Unified Payment Routing Key (UPRK) is a machine-executable routing key derived from namespace_address (or equivalent identifiers), plus version bindings such as snapshot_id or mapping_version and canonical_profile_id. UPRK is useful for multi-gateway deployments where clients submit a compact routing token rather than repeating all parameters.

UPRK derivation: uprk=H(namespace_address∥snapshot_id∥key version∥ttl_seconds∥nonce) uprk_signature=Sign(uprk, routing_key_private_key)//Verifier checks uprk_signature and TTL; then resolves to mapping_version+endpoints

UPRK does not narrow the claims; it is an selectively included implementation that improves deployment ergonomics and cache coherency.

### A.4 Deterministic Risk FSM Pre-Commit Gate (Overview)

In selectively included embodiments, deterministic risk gating is implemented as a finite-state machine (FSM) evaluated prior to atomic commit. The FSM emits auditable reason codes and maps deterministically to allow/deny/review outcomes. This supplements (not replaces) deterministic error paths (ERR_*) and may record results in receipt_record metadata.
States: NORMAL, RESTRICTED, FROZEN, ESCALATED, REVIEW.
Signals: velocity, geofence, exposure, endpoint integrity, policy-window mismatch, device attestation strength.
Outputs: decision token+reason_code token; both included in receipt_record for auditability.

### A.4.1 FSM Transition Table (Illustrative)

Transition table excerptCurrent Signal Condition Next reason_code NORMAL velocity_score>threshold RESTRICTED VEL_HIGH NORMAL geofence_violation==true REVIEW GEO_VIOL RESTRICTED exposure_limit_exceeded==true FROZEN EXP_MAX REVIEW manual_override==true NORMAL OVERRIDE_OK ANY endpoint_signature_invalid==true FROZEN EPR_SIG_FAIL

Decision mapping: NORMAL->ALLOW RESTRICTED->ALLOW_WITH_LIMITS REVIEW->HOLD_FOR_REVIEW FROZEN/ESCALATED->DENY

All comparisons and threshold lookups are deterministic, derived from policy_version_id and (in some embodiments) snapshot_id. No stochastic model output is required.

### A.4.2 Evidence Binding for FSM Decisions

FSM outputs should be evidence-grade: decision token, risk_state, and reason_code are persisted to receipt_record and, when used, bound into the append-only ledger metadata. This enables later reproduction of the gating outcome during disputes and due diligence.

Receipt metadata fields: risk_state=‘RESTRICTED’ reason_code=‘VEL_HIGH’ policy_version_id=‘PV2026.02’ threshold_matrix_digest=H(matrix_bytes)//in some embodiments: risk_score+threshold value

### A.4.3 32-Dimensional Risk Oracle Compatibility

A deterministic multi-dimensional risk oracle (such as 32-dimensional) may provide dim_i signals and a risk_score computed as a weighted sum of the dim_i features. Weights and thresholds are versioned policy parameters.

computation: risk_score=weighted_sum(dim_i, w_i) for i=1 . . . 32, where the weights w_i are policy-versioned and the weights sum to 1.

gating:

allow if risk_score>=threshold else emit_receipt(tx_hash, ERR_11, reason_code=‘RISK’) This preserves determinism while allowing privacy-preserving attestations for dim_i inputs (such as commitments or proofs) provided the verifier can recompute the decision predicate under the bound policy version and (in some embodiments) snapshot_id.

### A.5 Atomic Commit Boundary+Concurrency Control (Enterprise-Grade)

Atomic commit semantics prevent partial state visibility. Implementations may use database transactions, write-ahead logs, and optimistic concurrency checks. Conflicts emit ERR_09 (CONCURRENCY_CONFLICT) deterministically. Idempotency is enforced via tx_hash and/or an explicit idempotency key bound to nonce and policy version. optimistic concurrency predicate: require balance_version==expected_version require nonce_field==(nonce_requested−1) apply debit/credit commit; else rollback and emit ERR_09

### A.5.1 Idempotency Semantics

Idempotency prevents double execution under retries. If tx_hash is treated as an idempotency key, a repeated submission returns the prior receipt_record without reapplying balance changes. Idempotency may also be implemented as a separate idempotency_key stored with commit outcome.

if Seen(tx_hash): return StoredReceipt(tx_hash) else: execute atomic commit and store receipt

### A.6 Multi-Rail Finality Proof Set and Reconciliation Markers

When bridging to external rails, finality may be delayed or disputed. The system may record finality_marker, state_digest, reconciliation_marker, and rollback_proof to represent deterministic reconciliation outcomes without rewriting prior receipt_record entries.

### Fields:

### Field Definition Values/Notes

finality_marker Outcome marker for multi-rail settlement PENDING|FINAL|CONFLICT state_digest Digest of post-state for reconciliation H(domain_namespace∥account_id∥balances∥nonce)

reconciliation_marker Marker proving reconciliation completed RECONCILED or null if pending

rollback_proof Bounded rollback proof referencing receipt_record Selectively included; append-only

In CONFLICT, reconciliation appends rollback_proof and reconciliation_marker without rewriting prior_receipt_record entries.

### A.6.1 Settlement Matrix+Allocation Record

A settlement engine may compute deterministic allocations and include an allocation list commitment in reconciliation_marker metadata.

allocation_list_bytes=serialize([(node_id, amount_minor_units), . . . ]) allocation_digest=H(allocation_list_bytes) receipt_record.metadata.allocation_digest=allocation_digest This supports enterprise revenue splits and audit-ready fee accounting.

### A.6.2 Conflict Handling Example

Example: external rail acknowledges with a rejection after local prepare. The system records ERR_08 (RAIL_ACK_MISSING) or sets finality_marker=CONFLICT upon later conflict detection. A compensating transaction may be recorded and referenced by rollback_proof without mutating earlier ledger entries.

if ack_status_code==‘REJECTED’: finality_marker=‘CONFLICT’ rollback_proof=H(tx_hash∥‘COMPENSATE’∥compensating_tx_hash) append reconciliation entry

### A.7 Governance-to-Ledger Binding Deep Specification

Governance evidence (mapping_version evolution, routing rule updates, parameter changes) is bound to ledger evidence via update_digest and metadata_binding_hash. This prevents governance relocation to an off-ledger system without detection and strengthens licensing due diligence.

update_digest=H(governance_payload_bytes) metadata_binding_hash=H(byte-concatenation of block_hash and update_digest) store {update_digest, metadata_binding_hash} in receipt_record and/or governance entry

Verifiers recompute settlement integrity and governance integrity using the proof_set.

### A.7.1 Governance Payload Schema

governance_payload (illustrative): { mapping_version: ‘M05’, effective_start_s: 1730000000,
effective_end_s: 1730600000, endpoint_id: ‘EP-RAIL-001’, ack_fields_schema_id: ‘ACK-
SCHEMA-01’, canonical_profile_id: ‘P05’, jurisdiction_code_set: [‘US-CA’,‘US-NY’], signature:
<bytes> }

The governance payload is deterministic under a serialization profile; update_digest commits to the exact bytes used.

### A.7.2 Governance Verification Procedure

Algorithm: verify_governance_binding(tx_hash) 1 proof_set = GET /verify/{tx_hash} 2
recompute1 = H(proof_set.previous_hash || tx_hash) 3 require recompute1 ==
proof_set.block_hash 4 if proof_set.update_digest present: recompute2 =
H(proof_set.block_hash || proof_set.update_digest) require recompute2 ==
proof_set.metadata_binding_hash 5 return VALID

This verification is independent and does not require access to any internal governance database.

### A.8 Conformance Profile: Kernel Invariants

A conformance profile defines invariants for canonicalization, nonce gating, receipt fields, digest algorithms, rail acknowledgement schema, and governance binding. Profiles are referenced by profile_id and may be published by a standards portal.

kernel_profile (illustrative): profile_id: ‘KERNEL-PROFILE-2026-02’ hash_function_id: ‘SHA256’ canonical_profile_id: ‘P05’ ack_fields_schema_id: ‘ACK-SCHEMA-01’ required_receipt_fields: [tx_hash, status_code,previous_hash,block_hash] governance binding: true required_governance_fields: [update_digest,metadata_binding_hash]

### A.8.1 Deterministic Test Vectors (Excerpt)

Each vector defines inputs. Implementations must produce the same canonical_intent_envelope bytes, tx_hash, and (given previous_hash) the same block_hash. Vectors also support rail bridging and governance binding when enabled.

Test Vector 1from=merchant.us/alice to=bank.us/bob amount=1000 (minor units) nonce=1 timestamp=1700000060 (epoch seconds) canonical_profile_id=P05 expected:

canonical_intent_envelope bytes are byte-identical across implementations; tx_hash computed using hash_function_id.

Test Vector 2from=alice@merchant.us to=bank.us/bob amount=2000 (minor units) nonce=2 timestamp=1700000120 (epoch seconds) canonical_profile_id=P05 expected:

canonical_intent_envelope bytes are byte-identical across implementations; tx_hash computed using hash_function_id.

For rail bridging: derive rail_payload_bytes under mapping_version; compute rail_payload_digest; then compute rail_ack_digest over fixed ack schema (see Annex A Enhanced A.2).

### Page A-22 of 32

### A.8.2A Embodiment: Routing Gateway (BEIRouting-Compatible)

Routing is treated as a gateway that selects (mapping_version, rail_endpoint) under policy_version_id while the kernel clears canonical intents deterministically. Routing outputs are evidence-bound in receipt_record metadata to enable audit-replay, including jurisdiction_code_set for compliance replay. In this disclosure, the term routing_number is used as a human-recognizable routing identifier and is not limited to any legacy digit length. gateway and namespace examples (informational):

deployment examples (informational): a routing gateway service host, a terminal/dashboard host, a namespace directory host, and an audit/verification host. Specific domain names or brand identifiers are not required.

### Item Deterministic Definition

Inputs namespace_address, tx_hash, policy_version_id, jurisdiction_code_set, routing_rule_store_version

Outputs routing_number, mapping_version, rail_endpoint, route_reason_code; persisted in receipt_record metadata together with policy_ver

Legacy rail bridging When a transaction is mapped to a legacy rail (such as ACH/wire), routing_number MAY include or map to a legacy routing_number_Evidence Route decision MUST be reproducible given the same inputs and versions (policy_version_id+routing_rule_store_version+mapp

### Routing-Number Semantics:

routing_number MAY be represented as an alphanumeric identifier derived deterministically from namespace_address and snapshot_id (such as base32/base58 with checksum), or MAY be represented as a legacy numeric routing number when bridging to a legacy rail under mapping_version. In either case, routing_number is treated as an auditable routing artifact and SHOULD be recorded in receipt_record metadata for audit replay.

audit binding: routing_number MAY be represented as a legacy numeric routing number when bridging to legacy rails, or as a versioned domain-native routing number within the namespace; in all cases, routing_number is audit-replay bound to (policy_version_id, routing_rule_store_version, and jurisdiction_code_set).

### A.8.2B Embodiment: Time-Valued Minting (TimeCurrency/BEICurrency)

TimeCurrency/BEICurrency (labels) may be minted from verified events without changing the kernel boundary: minting produces canonical intents cleared through nonce_gate, atomic commit, append-only ledger, and proof_set verification. Verified event->mint intent: Step Deterministic treatment 1 Compute event_digest=H(event_proof) under hash_function_id; store in receipt_record metadata. This binding ensures value derivation is ancho 2 Derive amount=f(time units, policy_version_id) (rate/caps versioned; governance updates bound via update_digest). 3 Construct canonical_intent_envelope {from,to,amount,nonce,timestamp}; clear through kernel. 4 Emit receipt_record and proof_set enabling independent recomputation; apply ERR_10/ERR_11 as deterministic gates. Deterministic constraints: daily cap violations emit ERR_10 (POLICY_REJECTED); risk below threshold emits ERR_11 (RISK_BELOW_THRESHOLD). Offline minting may use offline_pre_authorization_token and reconcile with finality_marker handling.

### Page A-24 of 32

### A.8.4 Deterministic Test Vectors (Excerpt)

Each vector defines inputs. Implementations must produce the same canonical_intent_envelope bytes, tx_hash, and (given previous_hash) the same block_hash. Vectors also support legacy-rail bridging and governance binding when enabled.

### Vector InputsExpected

7 from=merchant.us/alice; to=bank.us/bob; amount=7000; nonce=7; timestamp=1700000420; canonical_profile_id=P05 canonical_intent_envelope bytes byte-identical; tx_hash under hash_function_id 8 from=alice@merchant.us; to=bank.us/bob; amount=8000; nonce=8; timestamp=1700000480; canonical_profile_id=P05 same as above; if rail bridging enabled: rail_payload_digest then rail_ack_diges

### A.8.4A Cross-Domain Policy Container (Policy Modules for 999 Needs/365 Industries)

In embodiments, heterogeneous use-cases (such as industry verticals, currency/resource classes, and jurisdictional rule-sets) are handled by loading versioned policy modules and binding the chosen policy state into evidence objects. A policy container is identified by snapshot_id and may include (at minimum) policy_version_id and jurisdiction_code_set, and may further include routing_rule_store_version and mapping_version for routing and rail-bridging replay. The active snapshot_id MUST be recorded in receipt_record metadata so that an auditor can recompute which policy module set was in effect for a committed transaction.

### Element Meaning Evidence Binding

policy_version_id Version identifier for policy parameters/rates/caps/thresholdsRecorded in receipt_record metadata; tied to snapshot_id

jurisdiction_code_set Jurisdictional compliance module selector (auto-injected by domain_namespace context) Recorded in receipt_record metadata; enables compliance replay

routing_rule_store_versionVersioned routing rule bundle for route selection Recorded in receipt_record metadata; enables route decision replay

mapping_version Versioned rail mapping for legacy-rail adapters Recorded in receipt_record metadata; binds rail digests to the same snapshot_id

snapshot_id Policy container identifier (policy_version_id+effective window+params digest) Auditable anchor for recomputation across receipts/proof_set

### Page A-25 of 32

### A.8.4B Namespace Address Alternatives (Beyond Domain Names)

In embodiments, the kernel does not require a domain name. The kernel operates on a namespace_address that resolves to an account_container. A domain_namespace is one selectively included namespace type; other namespace types are supported so long as resolution, canonicalization, and evidence binding remain deterministic. These alternatives broaden applicability while preserving the same proof_set and receipt_record evidence chain.

Namespace typeExample identifier(s) Deterministic resolution to namespace_address/account_container

Domain-based alice.example/dr.bei.chase Resolve domain_namespace->namespace_address via resolver; bind resolver_version in snapsho

Decentralized identifiers did:bei:123 . . . , did:key: . . . Resolve DID document/key material->namespace_address; bind did_method_id+doc_digest i

Account numbers/bank IDs IBAN, account_id, legacy routing number_9digit Map (bank_id, account_id)->namespace_address under mapping_version; bind rail mapping evid

Public keys/wallets secp256k1 pubkey, ERC-4337 address Normalize key->namespace_address; bind hash_function_id and key format_id

Human aliases email, phone, handle Resolve alias via versioned directory->namespace_address; bind directory_version_id and proof

Machine tokens QR/NFC token, hardware tag Decode token->namespace_address; bind device_attestation_digest and token_schema_id

### Determinism and Audit-Replay Requirements:

For any namespace type above, the resolver MUST emit versioned evidence sufficient for third-party recomputation. At minimum, receipt_record metadata SHOULD bind: (i) namespace type identifier (namespace_type_id), (ii) resolver_version_id or directory_version_id, and (iii) a digest of the resolution artifact (such as did_doc_digest, directory_digest, device_attestation_digest). The resulting namespace_address MUST be used to construct canonical_intent_envelope, tx_hash, and proof_set for audit replay.

### Page A-26 of 32

### A.8.4C Bank Adoption Module (Low-Friction Deployment)

In embodiments, a bank or payment institution may adopt the disclosed system with minimal change to existing rails by deploying a routing gateway and evidence-binding adapter as an additive layer (sidecar) that does not modify the core ACH/wire/RTP/FedNow processing stack. This module focuses on low-risk coexistence, audit replay, and reconciliation reduction, enabling incremental rollout prior to any full routing replacement.

Goal Bank-Side changeKernel/Evidence Object Impact

Phase 1—Input enhancement Add routing_number entry field and call routing gateway API; keep existing rails unchanged Emit route_reason_code, routing_number, mapping_version, rail_endpoint; bind policy_ve

Phase 2—Two-phase evidence After legacy rail submission, capture acknowledgement from bank rail adapter/correspondent; return ack digest Bind rail_payload_digest and rail_ack_digest under ack_schema_id and presence_rule_id;

Phase 3—Versioned policy replay Version internal routing/compliance rule bundles and expose version identifiers to audit teams Treat snapshot_id as policy container; enable third-party recomputation of which policy st

minimal API surface (illustrative):

Endpoint PurposeInputs/Outputs

POST/route Resolve routing_number to rail_endpoint under policy_version_id IN: routing_number, policy_version_id, jurisdiction_code_set; OUT: mapping_version, r POST/prepare Create rail_payload_digest and prepare two-phase bridging evidence IN: canonical_intent_envelope, mapping_version; OUT: rail_payload_digest, message_id POST/ack Bind rail_ack_digest using ack_schema_id and presence_rule_id IN: message_id, status_code, timestamp, amount; OUT: rail_ack_digest

Evidence-first adoption rationale: the bank can validate integration via conformance profiles and test vectors, and auditors can replay routing decisions and rail acknowledgements using receipt_record and proof_set without privileged access to internal mapping databases.

### A.8.7 Deterministic Test Vectors (Excerpt)

Each vector defines inputs. Implementations must produce the same canonical_intent_envelope bytes, tx_hash, and (given previous_hash) the same block_hash. Vectors also support rail bridging and governance binding when enabled.

Test Vector 13from=merchant.us/alice to=bank.us/bob amount=13000 (minor units) nonce=13 timestamp=1700000780 (epoch seconds) canonical_profile_id=P05 expected: canonical_intent_envelope bytes are byte-identical across implementations; tx_hash computed using hash_function_id.

Test Vector 14from=alice@merchant.us to=bank.us/bob amount=14000 (minor units) nonce=14 timestamp=1700000840 (epoch seconds) canonical_profile_id=P05 expected: canonical_intent_envelope bytes are byte-identical across implementations; tx_hash computed using hash_function_id.

For rail bridging: derive rail_payload_bytes under mapping_version; compute rail_payload_digest; then compute rail_ack_digest over fixed ack schema (see Annex A Enhanced A.2).

### A.8.8 Deterministic Test Vectors (Excerpt)

Each vector defines inputs. Implementations must produce the same canonical_intent_envelope bytes, tx_hash, and (given previous_hash) the same block_hash. Vectors also support rail bridging and governance binding when enabled.

Test Vector 15from=merchant.us/alice to=bob@bank.us amount=15000 (minor units) nonce=15 timestamp=1700000900 (epoch seconds) canonical_profile_id=P05 expected: canonical_intent_envelope bytes are byte-identical across implementations; tx_hash computed using hash_function_id.

Test Vector 16from=alice@merchant.us to=bank.us/bob amount=16000 (minor units) nonce=16 timestamp=1700000960 (epoch seconds) canonical_profile_id=P05 expected: canonical_intent_envelope bytes are byte-identical across implementations; tx_hash computed using hash_function_id.

For rail bridging: derive rail_payload_bytes under mapping_version; compute rail_payload_digest; then compute rail_ack_digest over fixed ack schema (see Annex A Enhanced A.2).

### A.9 Receipt Verifier Interface

A receipt verifier is a reference implementation that validates proof_set responses for settlement and governance binding. It improves licensing and diligence by providing a turnkey verification tool.

Endpoints (illustrative): GET/verify/{tx_hash}->{proof_set, valid}GET/proof_set/{tx_hash}->{proof_set}GET/receipt/{tx_hash}->{receipt_record}GET/conformance/{profile_id}->{kernel_profile}

Verifier steps: 1) recompute_settlement 2) recompute_governance (if update_digest present) 3) validate required fields and schema ids

The verifier does not require access to account balances or private keys; it validates integrity evidence only.

### A.9.1 Diligence Checklist (Technical,)

Confirm canonical_profile_id and hash_function_id are returned in proof_set for every tx_hash.
Confirm status_code table is closed-set and included in receipt_record even for failures (deterministic error paths).
Confirm ack_fields schema is fixed-order, typed, and versioned by mapping_version; rail_ack_digest is recomputable.
Confirm update_digest and metadata_binding_hash are returned when governance binding is enabled.
Confirm idempotency semantics: repeated tx_hash returns prior receipt_record without state mutation.
Confirm offline_pre_authorization_token and offline cache hash-chaining protect offline capture integrity.

This checklist is suitable for technical due diligence and conformance testing and does not narrow the scope of the claims.

### A.10 Portfolio Integration Context (BEI-GENESIS Full Stack,)

The deterministic kernel serves as the proof-carrying settlement spine for broader systems such as: Domain-as-Financial-Account addressing (namespace_address->account_container), BEICX clearing microservice deployments, routing gateways (human-readable routing replacing numeric identifiers), terminal/ATMS-class devices for offline capture and later synchronization, and time-valued minting flows where verified events produce canonical intents cleared by the kernel.

These integrations are technical contexts; the kernel claims remain focused on deterministic canonicalization, nonce gating, evidence receipts, multi-rail binding, and governance integrity.

### A.10.1 Separation-of-Concerns for Fast Allowance

For examination strategy, this filing keeps the core deterministic boundary stable and claimable (canonical_intent_envelope->tx_hash->receipt_record->block_hash, plus multi-rail digests and governance binding). Higher-level ecosystem modules (minting policy, UI portals, nation-scale governance) are described as selectively included embodiments and can be protected via continuations without risking the core allowance path.
Main claim set remains implementable as a kernel in enterprise clearing or fintech systems.
Selectively included annexes provide enough detail for diligence and licensing without narrowing.
Governance binding is a key differentiator that increases licensing value while staying technical.

### ANNEX B. DETERMINISTIC SERIALIZATION EDGE CASES

This annex provides additional guidance on edge cases that commonly cause digest divergence across implementations, and therefore are normalized by the canonicalization profile.

Leading zeros: integer encodings SHALL be canonical and SHALL NOT preserve presentation-oriented leading zeros; implementations reject ambiguous encodings unless explicitly permitted by the canonicalization profile.

Sign handling: amounts MAY be restricted to non-negative int64; if negative values are permitted for reversals, the canonicalization profile defines a unique sign representation.

Floating-point avoidance: amounts SHOULD be represented as integers in smallest units; if decimals are accepted as input, they are deterministically converted to integer units prior to canonicalization.

Delimiter safety: if a delimiter-separated encoding is used, the canonicalization profile defines an escaping rule or forbids delimiter characters in identifier fields.

Timestamp skew: the canonicalization profile MAY define a deterministic acceptance window for timestamp values; values outside the window are rejected using deterministic error paths.

String normalization: identifiers are normalized under a declared policy (such as ASCII lower-case) to prevent multiple spellings from producing distinct digests for the same intent.

### ANNEX C. BEI-GENESIS PORTFOLIO CONTEXT

ANNEX C. BEI-GENESIS PORTFOLIO CONTEXT This annex provides a portfolio context in which the disclosed domain-anchored deterministic clearing kernel functions as the proof-carrying settlement spine for a broader BEI-GENESIS ecosystem. Domain-as-Financial-Account. In some embodiments, each namespace address (domain namespace+account identifier) is treated as a permanent financial account handle, where the account container is the authoritative state object and the namespace address is the user-facing account reference. BEICX clearing kernel. In some embodiments, the deterministic clearing kernel is deployed as a clearing microservice (BEICX) exposing deterministic APIs for canonicalization, signature verification, nonce gating, receipt record emission, and proof set retrieval, thereby enabling consistent settlement semantics across multiple front-ends. BEIRouting replacement of numeric routing identifiers. In some embodiments, a routing gateway accepts a human-readable namespace address (such as account_id@domain namespace) as the routing destination, and the legacy rail adapter deterministically maps to institution-specific endpoints under mapping_version. Physical ATMS terminal interface. In some embodiments, the terminal device of claim 3 is implemented as an ATM-class device that captures verified events and produces signatures over tx_hash for offline capture and later synchronization, with the offline cache hash-chaining receipts for tamper evidence. Time-valued minting context. In some embodiments, a verified event corresponds to an audited unit of time contribution; the resulting mint instruction is encoded as a canonical intent envelope and cleared using the deterministic kernel, producing receipt records and ledger blocks that are independently recomputable. Behavioral risk oracle. In some embodiments, a multi-dimensional risk oracle produces a deterministic risk_score used as an additional gating predicate. The risk_score computation, its inputs, and the policy threshold may be bound into receipt record metadata as a policy-version identifier output, preserving determinism and auditability. risk score computation (example): risk score=weighted_sum(dim_i, w_i) for i=1.32 where dim_i are normalized to [0,1] under a declared policy version, and weights sum to 1. Example gating: - allow if risk_score>=threshold-otherwise emit receipt record with status_code POLICY_REJECTED

The 32-dimensional signals may include, without limitation: consistency metrics, historical integrity metrics, device/terminal attestation strength, geographic consistency, counterparty graph metrics, and policy-alignment metrics. The exact semantics are implementation-specific and may be stored as policy-versioned parameters.

### 32-Dimensional Signals

dim_01 dim_02 dim_03 dim_04
dim_05 dim_06 dim_07 dim_08
dim_09 dim_10 dim_11 dim_12
dim_13 dim_14 dim_15 dim_16
dim_17 dim_18 dim_19 dim_20
dim_21 dim_22 dim_23 dim_24
dim_25 dim_26 dim_27 dim_28
dim_29 dim_30 dim_31 dim_32

Portfolio integration. The deterministic kernel is designed to be licensable and deployable as infrastructure for bank-grade routing replacement and audit-ready settlement; the annex is provided to preserve the broader integration context while keeping the claimed core deterministic boundary stable for examination and enforcement.

### ANNEX D—ELEMENT-BY-ELEMENT CLAIM SUPPORT CHARTS FOR CLAIMS 1-3

Purpose. This annex provides examiner- and diligence-ready locator charts mapping each element of Claims 1-3 (a)-(i) to supporting disclosure in this Specification, including section identifiers and figure references. These charts are and are provided to reduce 35 U.S.C. § 112 risk by making written-description and enablement support explicit without narrowing claim scope.

Locator conventions: References such as “VII/FIG. 2” indicate a section and figure in this Specification where supporting disclosure appears. References such as “Annex A.2” indicate enhanced implementation notes supporting enterprise embodiments. These charts provide representative anchors to written-description and enablement support and do not limit claim scope.

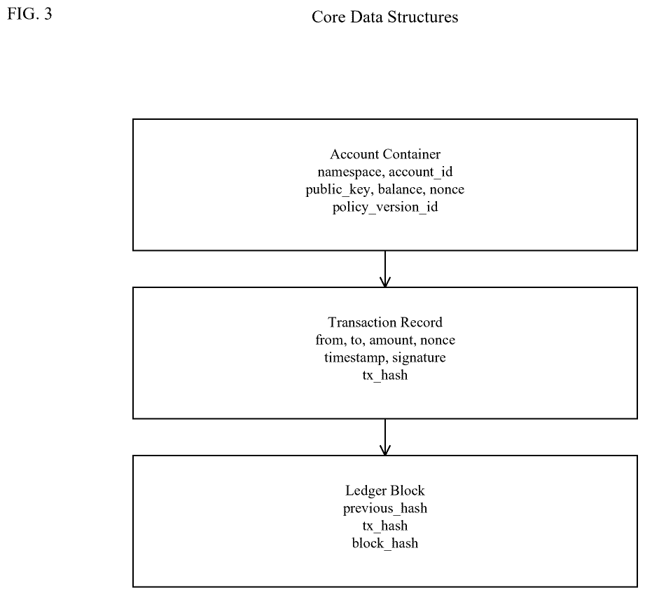

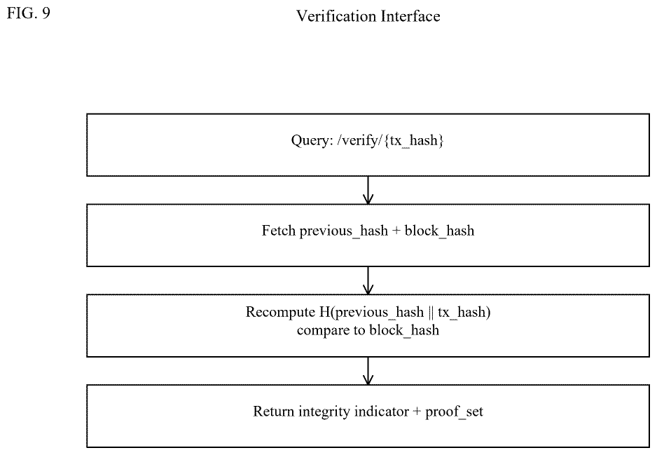

D.1 Claim 1 Support Chart (Elements (a)-(i))

| | Support | |
|---|---|---|
| Claim element | (Spec/Annex/FIG) | Key support summary |
| (a) namespace parser/ | VII; FIG. 2; Annex A.2 | Parses |
| hierarchical account | | namespace_address |
| graph | | into namespace + |
| | | account_id; selectively |
| | | included hierarchical |
| | | path mapping yields |
| | | parent/child account |
| | | nodes. |
| (b) inheritance rule | Annex A.2.1; Annex | Deterministic override |
| engine | A.2 | precedence across |
| | | ancestors; produces |
| | | effective_parameter_{—} |
| | | set and params_digest. |
| (c) snapshot_id | Annex A.3; Appendix | snapshot_id binds |
| binding policy + time | Table C | policy_version_id, |
| window | | effective window, |
| | | params_digest (and |
| | | selectively included |
| | | cache token) to |
| | | prevent drift. |
| (d) canonicalization | VIII-IX; FIG. 5 | Byte-identical |
| profile + tx_hash | | canonical_intent_{—} |
| | | envelope under |
| | | canonical_profile_id; |
| | | tx_hash computed |
| | | under |
| | | hash_function_id; |
| | | signature verified. |
| (e) unified payment | Annex A.3.1; Annex | Machine routing token |
| routing key (UPRK) | A.8.2A | derived from |
| | | namespace_address |
| | | and snapshot_id with |
| | | TTL, replay- |
| | | prevention material, |
| | | and key_version; |
| | | supports key rotation. |
| (f) deterministic risk | Annex A.4-A.4.3; | Pre-commit finite-state |
| FSM gate | Table (reason codes) | risk gating emits |
| | | auditable |
| | | reason_code/risk_state; |
| | | deterministic |
| | | thresholds under |
| | | policy_version_id/ |
| | | snapshot_id. |
| (g) atomic commit + | X-XII; FIG. 8; Annex | nonce_requested == |
| nonce gate + | A.5 | nonce_stored + 1; |
| idempotency | | idempotency via |
| | | tx_hash; atomic |
| | | debit/credit and |
| | | concurrency control; |
| | | deterministic failure |
| | | receipts. |
| (h) append-only audit | XII; FIG. 6; Appendix | Append-only tamper- |
| log/ledger | Table A | evident log/ledger |
| commitments | | chaining; block_hash = |
| | | H(previous_hash ∥ |
| | | tx_hash); binds |
| | | status_code and key |
| | | metadata. |
| (i) settlement matrix + | Annex A.2.2; Annex | Deterministic |
| reconciliation records | A.6-A.6.1 | allocation across |
| | | account-graph edges; |
| | | reconciliation |
| | | markers/finality |
| | | markers; |
| | | allocation_digest |
| | | commitments. |
| wherein verification | XIII; | Third party |
| interface returns | FIG. 7/FIG. 9/FIG. 10; | recomputes canonical |
| proof_set | Annex A.9 | bytes and ledger |
| | | integrity predicates; |
| | | selectively included |
| | | governance binding |
| | | via |
| | | metadata_binding_hash. |

| Element | Claim element (short) | Support locator(s) | §112/diligence notes |
|---|---|---|---|
| 1(a) | Resolve namespace | V; VII; Annex A.2; | Deterministic path |
| | address into | FIG. 2; FIG. 3 | derivation and |
| | hierarchical account | | account_container |
| | graph/account | | mapping support the |
| | containers | | parser and parent/child |
| | | | graph. |
| 1(b) | Deterministic | Annex A.2.1; Annex | Override precedence |
| | inheritance/override | A.3 | table + params_digest |
| | precedence to compute | | binding support |
| | effective parameter set | | deterministic effective |
| | | | parameters. |
| 1(c) | Generate snapshot_id | Annex A.3; Table C | snapshot_id |
| | binding policy version + | (policy container | construction ties |
| | time window to | binding) | policy_version_id + |
| | parameter set | | effective window + |
| | | | params_digest; |
| | | | supports cache |
| | | | coherency. |
| 1(d) | Canonicalize to byte- | VIII; IX; FIG. 5; FIG. 7 | Deterministic |
| | identical envelope | | boundary at canonical |
| | under | | intent envelope |
| | canonical_profile_id; | | enables |
| | compute tx_hash | | recomputation; |
| | under | | signature verification |
| | hash_function_id; | | over tx_hash. |
| | verify signature | | |
| 1(e) | Generate machine- | Annex A.3.1; XVII | UPRK derivation |
| | executable routing key | | includes ttl_seconds |
| | (UPRK) using | | and nonce; |
| | snapshot_id; include | | signature/TTL checks |
| | replay prevention + | | are deterministic. |
| | TTL | | |
| 1(f) | Deterministic risk | Annex A.4-A.4.3; X | FSM |
| | FSM gate prior to | | states/signals/transition |
| | atomic commit; emit | | table; reason_code |
| | auditable reason codes | | persisted as evidence. |
| 1(g) | Atomic debit-credit at | XI; X; Annex A.5- | Atomic commit |
| | atomic commit | A.5.1 | semantics + |
| | boundary with | | idempotency + nonce |
| | idempotency and | | predicate; |
| | nonce gate; | | deterministic conflict |
| | concurrency control | | receipts. |
| 1(h) | Persist tamper-evident | XII; XI; XV; FIG. 6 | Ledger chaining |
| | audit commitments in | | (previous_hash∥tx_hash) |
| | append-only log | | yields tamper- |
| | | | evident audit trail; |
| | | | offline hash chaining |
| | | | selectively included. |
| 1(i) | Apply settlement | Annex A.2.2; Annex | Settlement allocations |
| | matrix; generate | A.6-A.6.1; XIII; XIV | and reconciliation |
| | reconciliation records; | | markers are evidence- |
| | expose proof_set for | | bound; proof_set |
| | recomputation | | enables third-party |
| | | | verification. |

Note:
Claims 2 and 3 correspond to method and computer-readable medium forms of Claim 1. Element-by-element support locators for Claims 2 and 3 are provided by the same Specification/FIG/Annex anchors identified in Section VI.C (Claim-to-Support Map) and Annex D.1.

### ANNEX E—CONFORMANCE PROFILES, INTERFACE CONTRACT, AND TEST VECTORS

Purpose. This annex provides conformance artifacts to support licensing, third-party audit, and § 112 enablement. The artifacts define interface expectations and example test vectors for canonicalization, hashing, nonce gating, and proof-set recomputation. These artifacts are and illustrative; implementations may vary while remaining within the scope of the Claims.

### E.1 Verification Interface Contract (Illustrative).

get_proof_set(namespace_address, tx_hash)->{tx_hash, previous_hash, block_hash, hash_function_id, canonical_profile_id, snapshot_id, anchor_data, receipt_record_digest}.
verify_receipt(receipt_record, proof_set)->{valid, recomputed_tx_hash, recomputed_block_hash, reason_code}.
recompute_tx_hash(canonical_profile_id, intent_fields)->tx_hash (byte-identical across clients).

### E.1A Conformance Profile Identifiers and Acceptance Criteria.

| Identifier | Meaning | Acceptance criterion |
|---|---|---|
| kernel_{—} | Published profile for an | Declared by implementation; |
| profile_id | implementation family | referenced by |
| | | auditors/acquirers |
| canonical_{—} | Canonicalization rules | Canonical bytes MUST |
| profile_id | for canonical intent | match test vectors; tx_hash |
| | envelope | MUST match |
| hash_{—} | Hash function identifier | tx_hash MUST match under |
| function_id | for tx_hash and digests | declared hash_function_id |
| ack_{—} | Ack-field ordered set for | Ack serialization MUST |
| schema_id | rail_ack_digest | match; rail_ack_digest |
| | | MUST match |
| presence_{—} | presence-variable field | presence-variable fields |
| rule_id | presence rules | MUST be present/absent |
| | | exactly per rule; digest |
| | | MUST match |
| mapping_{—} | Rail mapping rules for | rail_payload_digest MUST |
| version | legacy payload | match under |
| | | mapping_version |

### E.2 Canonicalization+tx_hash Test Vector (Illustrative).

Canonicalization profile (illustrative): UTF-8 encoding; LF newline; key order fixed as: account_id, namespace, amount, currency, nonce, effective_window; ‘key=value’ per line; no trailing spaces.

Canonical intent envelope bytes (illustrative):
account_id=ALICE
namespace=example.bank
amount=100
currency=USD
nonce=41
effective_window=2026-02-28T00:00:00Z..2026-03-01T00:00:00Z
tx_hash = SHA-256(canonical_intent_envelope_bytes) =
c4c95e36a2baa7d6d2cf7a9d7b7a249fac13ae194e3117df7df3c7b9c2e82836

### E.3 Nonce Gate Predicate Example (Illustrative).

Given nonce_stored=40 and nonce_requested=41, admit execution if and only if nonce_requested==nonce_stored+1; otherwise emit a deterministic receipt_record with status_code indicating REPLAY_OR_OUT_OF_ORDER.

### E.4 Proof Set Recomputation Example (Illustrative).

Given previous_hash (hex)=0000000000000000000000000000000000000000000000000000000000000000 and tx_hash (hex)=c4c95e36a2baa7d6d2cf7a9d7b7a249fac13ae194e3117df7df3c7b9c2e82836, an illustrative recomputation is block_hash=SHA-256(previous_hash∥tx_hash)=21f83f106b9c9c4dd888001cb270ac3eeec9fc7e816b13b50dd68a85ecd18f78. (Note: ‘∥’ denotes byte-concatenation in the implementation's canonical encoding.)

### E.5 Deterministic Vector Suite (TV_01 . . . TV_10).

A full deterministic vector suite (TV_01 . . . TV_10) with canonical_bytes_ascii and expected digests is provided in the Supplemental Exhibit for diligence and conformance testing; two representative vectors are kept inline below (non-limiting).

| | canonical_{—} | hash_function_{—} | | canonical_bytes_{—} |
|---|---|---|---|---|
| vector_id | profile_id | id | tx_hash_sha256 | ascii (excerpt) |
| TV_01 | CP_01 | HF_SHA256 | 9de6c6a54b08f4 | from=acct_A01\|t |
| | | | c5c5ab05bdd11f | o=acct_B01\|amo |
| | | | 9a5f5487c650ae | unt_minor=1003 |
| | | | 3e9ca60dad287f | 7\|currency=USD |
| | | | e7b54366 | T\|nonce=1\|times |
| | | | | tamp_s=173000 |
| | | | | 0060 |
| TV_05 | CP_02 | HF_SHA256 | a3d376236ebb0 | ...\|routing_num |
| | | | 13b064716b5c6f | ber=UPRK-05- |
| | | | 078dd2363c6c6 | X7Q9\|jurisdictio |
| | | | bded14f7ffc6b4e | n_code_set=US_{—} |
| | | | cfa3dd9bb | CA |

The following vectors provide deterministic canonical_bytes_ascii strings and expected SHA-256 digests for tx_hash, rail_payload_digest, and rail_ack_digest. These vectors are illustrative and do not narrow claim scope; equivalent vectors may be used under different canonical_profile_id, mapping_version, ack_schema_id, and presence_rule_id values.

### E.6 Receipt Verifier (Audit Replay Interface).

A verifier may expose an interface such as GET/verify/{tx_hash} that accepts a proof_set and a receipt_record, recomputes canonical intent bytes under canonical_profile_id, recomputes tx_hash under hash_function_id, recomputes block_hash as H(previous_hash∥tx_hash), recomputes rail_ack_digest under ack_schema_id and presence_rule_id (when present), and confirms governance-to-ledger binding by recomputing metadata_binding_hash=H(block_hash∥update_digest) (when update_digest is present). The verifier returns PASS/FAIL plus deterministic reason_code values.

Closed-set verifier reason_code examples:

| reason_code | Deterministic meaning |
|---|---|
| PASS | All recomputation predicates satisfied; |
| | evidence objects consistent. |
| CANONICAL_BYTES_MISMATCH | Recomputed canonical_intent_envelope bytes |
| | differ from provided canonical bytes or from |
| | bytes implied by receipt_record fields. |
| TX_HASH_MISMATCH | Recomputed tx_hash under hash_function_id |
| | does not match tx_hash. |
| BLOCK_HASH_MISMATCH | Recomputed H(previous_hash ∥ tx_hash) does |
| | not match block_hash. |
| ACK_DIGEST_MISMATCH | Recomputed rail_ack_digest under |
| | ack_schema_id and presence_rule_id does not |
| | match provided digest. |
| PRESENCE_RULE_VIOLATION | presence-variable field presence differs from |
| | presence_rule_id requirements. |
| GOVERNANCE_BINDING_MISMATCH | Recomputed H(block_hash ∥ update_digest) |
| | does not match metadata_binding_hash. |
| SCHEMA_ID_MISSING | Required schema/version identifiers missing |
| | from receipt_record/proof_set for |
| | recomputation. |

### ANNEX F—DESIGN-AROUND RESISTANCE AND CROSS-LAYER PROTECTION STRATEGY

Purpose. This annex identifies ‘kernel invariants’ that produce the disclosed technical effects, and describes how embodiments preserve those invariants even if components are renamed, re-partitioned, or deployed across multiple services. This discussion is engineering-oriented and.

### F.1 Kernel Invariants.

Byte-identical canonical intent envelope under a declared canonicalization profile (prevents digest drift).
Nonce-gated, idempotent atomic commit boundary with deterministic error receipts (prevents replay/double-execution).
Proof set enabling third-party recomputation of integrity predicates (enables independent audit without privileged database access).
Version-bound routing and policy context (snapshot_id, mapping_version, policy_version_id) captured as evidence objects to prevent rule drift.
Two-phase legacy rail evidence digests (rail_payload_digest, rail_ack_digest) with schema-validated presence rules (ack_schema_id, presence_rule_id) to make interoperability auditable.

### F.2 Cross-Layer Claiming Opportunities (for Continuation Filings).

Proof-object pillar: claims centered on receipt_record/proof_set schema+recomputation predicates.
Interop pillar: claims centered on two-phase rail evidence+schema-governed presence-variable fields.
Governance pillar: claims centered on governance-to-ledger binding and verifiable policy updates.
Enterprise graph pillar: claims centered on hierarchical account graph+settlement matrix+snapshot binding.

### F.3 Evidence of Use and Black-Box Observability (Non-Limiting).

In some embodiments, the disclosed kernel produces externally observable, recomputable evidence objects that can be collected from integration logs, conformance disclosures, verifier interfaces, or rail-bridge transcripts without requiring privileged access to internal database state. Such observability supports integration testing, regulatory audit, and licensing diligence by enabling a third party to confirm use of the deterministic canonicalization, evidence binding, and governance-to-ledger coupling described herein.

Representative evidence-of-use indicators (illustrative; not limiting) include one or more of the following:
A byte-identical canonical intent envelope generated under a declared canonical_profile_id (or equivalent profile identifier), such that independent recomputation yields the same tx_hash.
A proof_set (or equivalent proof-carrying object) that includes canonical_profile_id, mapping_version, and one or more of rail_payload_digest, rail_ack_digest, previous_hash, or block_hash enabling verifier-side reconstruction.
Schema-governed presence-variable rail acknowledgements, evidenced by ack_schema_id and presence_rule_id (or equivalents) and corresponding digests over canonicalized payload/ack bytes.
A governance binder output (such as update_digest and/or metadata_binding_hash) that cryptographically binds policy_version_id and parameter snapshots to committed transaction evidence.
A verifier interface that accepts a proof_set and returns deterministic decision_code/reason_code drawn from a closed set, enabling fail-closed mismatch detection.

The foregoing indicators are provided to illustrate observability of kernel adoption; actual implementations may expose equivalent fields or interfaces consistent with the claims and the versioned schema and conformance profiles described herein.

### F.4 Evidence-of-Use to Claim-Element Mapping (Non-Limiting).

Table F-EOU-1 provides an illustrative mapping between externally observable evidence artifacts and representative claim elements. The mapping is non-limiting; implementations may expose equivalent fields, receipts, or interfaces consistent with the claims and the versioned schemas/conformance profiles described herein.

| Externally observable | Typical black-box collection | Representative claims/ |
|---|---|---|
| indicator (illustrative) | point (illustrative) | elements (non-limiting) |
| canonical_profile_id + byte- | Receipt/verifier response; | Claim 1(d), 2(e), 3(d); Claim |
| identical canonical intent | captured request/response | 1 (verification interface |
| envelope; tx_hash | bytes; integration logs | clause) |
| recomputable under | | |
| hash_function_id | | |
| snapshot_id binding | Receipt_record/proof_set | Claim 1(c), 2(d), 3(c); Claim |
| policy_version_id and | fields; audit export; verifier | 6 (receipt_record metadata |
| effective time window | reconstruction output | includes policy_version_id) |
| Unified Payment Routing | Routing key observed at API | Claim 1(e), 2(f), 3(e) |
| Key (UPRK) including key | boundary, terminal logs, or | |
| version, TTL, and replay- | receipt metadata | |
| prevention material | | |
| deterministic risk gating with | decision_code/reason_code | Claim 1(f), 2(g), 3(f); Claim |
| reason codes prior to atomic | in receipts; verifier interface | 16 (32-dim risk vector |
| commit boundary | output | embodiment); Claim 11 (risk |
| | | FSM states) |
| nonce gate + idempotency | nonce/idempotency fields in | Claim 1(g), 2(h), 3(g) |
| protection on atomic debit- | receipts; rejection receipts for | |
| credit transformation | replay attempts | |
| append-only tamper-evident | audit export; reconciliation | Claim 1(h)-(i), 2(i), 3(h) |
| audit log commitments; | records; hash-chain receipts | |
| settlement matrix | (previous_hash/block_hash) | |
| reconciliation outputs | | |
| verification interface returns | verifier API response | Claim 1 (wherein clause), |
| proof_set enabling third-party | returning proof_set; | 2(i), 3(i) |
| recomputation | published verification | |
| | endpoint | |
| two-phase legacy rail | rail-bridge transcripts; | Claim 4; Claim 6 |
| evidence: mapping_version + | acknowledgement artifacts; | (ack_schema_id, |
| rail_payload_digest + | receipts containing | presence_rule_id in |
| rail_ack_digest; | digests/schemas | receipt_record metadata) |
| ack_schema_id + | | |
| presence_rule id | | |
| governance binder evidence: | governance update receipts; | Claim 20(ii) |
| update_digest and | audit export; published | |
| metadata_binding_hash = | update attestation | |
| H(block_hash ∥ | | |
| update_digest) | | |
| conformance record + | public conformance | Claim 20(iii) |
| published kernel profile/test | disclosure; test vector bundle; | |
| vectors; receipt-verification | conformance-mode verifier | |
| interface verifies proof_sets | output | |
| and rail digests | | |

Note:
The foregoing mapping is illustrative; equivalent evidence objects, digests, receipts, and interfaces may indicate use of the claimed kernel.

### F.5 Evidence-of-Use Sampling Protocol (Non-Limiting).

This section provides illustrative, non-limiting sampling procedures that a diligence team, regulator, or patent owner may perform against a deployed payment or clearing system. The procedures may be performed using only externally observable artifacts (API responses, receipts, logs, or traces). No privileged access to internal account databases or confidential ledger state is required to obtain evidence of use for the disclosed proof-carrying structures and bindings.
(1) Proof Set capture and independent recomputation.
   (a) Invoke a receipt or verifier interface (such as a “get_proof_set” or “verify” endpoint) using an externally available transaction handle (such as tx_handle, tx_hash, or receipt id) and capture the returned proof_set (or equivalent proof-carrying object).
   (b) Confirm the proof_set includes, at minimum, canonical_profile_id, mapping_version, rail_payload_digest, rail_ack_digest, and metadata_binding_hash (or equivalent fields as disclosed), and that decision_code/reason_code are drawn from a closed set.
   (c) Independently recompute tx_hash from the canonical intent envelope under canonical_profile_id, and verify (i) signature validity, (ii) nonce-gate acceptance/rejection determinism, and (iii) that the recomputed settlement predicate matches the returned decision_code.
(2) Two-phase legacy rail evidence sampling.
   (a) Observe (via API response, log export, or network trace) the rail prepare submission for a representative payment and record the associated rail_payload_digest.
   (b) Observe the corresponding rail acknowledgement (commit/settlement confirmation) and record rail_ack_digest.
   (c) Verify that the pair (rail_payload_digest, rail_ack_digest) is bound into the same receipt_record/proof_set as tx_hash, and that any declared ack_schema_id and presence_rule_id are consistent with the acknowledgement's presence/absence behavior.
(3) Governance-to-ledger binding sampling.
   (a) Retrieve the current policy_version_id and update_digest (such as from a published policy registry, conformance_record, or update receipt).
   (b) For a transaction cleared under that policy version, obtain metadata_binding_hash (or equivalent governance binding field) from the receipt_record/proof_set.
   (c) Verify that metadata_binding_hash binds update_digest (and any declared parameter snapshot) to the transaction evidence, such that a policy change produces a distinct binding and is detectable by independent recomputation.
(4) Namespace resolver and downgrade-detection sampling.
   (a) Submit a resolution request for a human-readable namespace address (such as account_id@domain namespace) and capture the resolver output (such as resolver_transcript_digest and resolved routing key).
   (b) Verify that the observed mapping_version is consistent with a published registry state and that a downgrade (older mapping_version or prior routing key) is rejected or yields a deterministic failure receipt.
   (c) Optionally, repeat resolution across two client implementations and confirm that canonicalization under canonical_profile_id yields byte-identical canonical intent envelopes for the same intent fields.

TABLE F
EOU-2 provides an illustrative evidence strength level and
target licensee profile for each sampling protocol above.

| Sampling protocol | Evidence | Most relevant targets/ |
|---|---|---|
| (illustrative) | strength | licensees (illustrative) |
| (1) Proof Set capture + | Strong | Banks; clearinghouses; |
| independent | | CBDC/payment network |
| recomputation | | operators; auditors; regulators |
| (2) Two-phase rail evidence | Strong | SWIFT/ISO 20022 |
| (payload/ack digests) | | integrators; |
| | | ACH/wire/FedNow/RTP |
| | | operators; core banking |
| | | vendors; payment processors |
| (3) Governance-to-ledger | Strong | Protocol operators; |
| binding (update_digest → | | compliance/risk platforms; |
| metadata_binding_hash) | | regulated banks; CBDC |
| | | governance operators |
| (4) Namespace resolver + | Medium- | Wallet/terminal vendors; |
| downgrade detection | Strong | gateways; alias/ID providers; |
| | | routing registry operators |

### ANNEX K—MODULE BANK AND INCORPORATION BY REFERENCE (NON-LIMITING)

This specification is an integrated disclosure. Related applications in the BEI/ATMS module family may be incorporated by reference for non-limiting embodiments, including to provide additional implementation details, alternative architectures, optional interfaces, and exemplary receipt/evidence objects consistent with the kernel-level deterministic execution model described herein. Unless expressly stated, incorporation by reference is for non-limiting embodiments and does not disclaim any scope. A non-limiting module bank index is provided in ANNEX K. MODULE BANK INDEX (NON-LIMITING EXAMPLES)

| | Abbreviated module bank index (non- |
|---|---|
| Category | limiting) |
| C | 19/448,144 - Unified Resolution-as- |
| | Evidence Protocol (policy-enforced |
| | resolution) |
| C | 19/067,732 - Cross-border payments & real- |
| | time settlement |
| C | 19/387,452 - Interbank clearing + FR2 |
| | reversible settlement |
| C | 19/315,561 - Dual anchoring + atomic |
| | clearing + rollback infrastructure |
| C | 19/408,106 - Global sovereign banking + |
| | multicurrency clearing + regulatory infra |
| D | 19/385,771 - BEI Wallet + minting |
| | architecture + FR2 |
| D | 19/406,982 - Anchor-based reversible |
| | clearing & payment system + terminals |
| D | 19/412,863 - Fee-to-mint engine + tri-ledger |
| | payment-to-currency |
| D | 19/439,296 - Domain-namespace energy |
| | grid policy-gated routing |
| D | 19/415,394 - Bank engine: |
| | minting/rollback/capital control/banking |
| | standards |
| D | 19/445,659 - Terminal-centric basepoint |
| | binding + time-ring accounting |
| D | 19/183,864 - Time/action/domain-linked |
| | authentication |

Additional module-bank entries, full interface evidence mappings, and licensing tables are provided as a separate Supplemental Exhibit (non-limiting) and do not limit the claims.

### K.1 Module-to-Kernel Interface Map (Non-Limiting)

Table K-1 below provides a non-limiting, illustrative mapping between representative modules in the Module Bank Index and example integration touchpoints of the deterministic kernel disclosed herein. The mapping is provided for interoperability illustration and diligence convenience and does not limit the claims. Sampling Path IDs in the final column reference the non-limiting Evidence-of-Use Sampling Protocols in ANNEX F.5 (P1-P4).

### ANNEX L—SUPPLEMENTAL NON-LIMITING SUPPORTING EMBODIMENTS (ASSETIZATION ADDENDUM)

This Annex provides additional non-limiting embodiments and diligence-oriented technical context that may improve interoperability, auditability, and licensing clarity, without limiting the claims.

### L.1 Interoperability Profile: ISO 20022/Legacy Rail Bridging (Non-Limiting)

In certain embodiments, the legacy-rail adapter maps between a canonical intent envelope and representative ISO 20022 message families. The mapping is versioned (mapping_version) and the resulting rail payload and rail acknowledgement digests are bound into the proof_set for independent recomputation.

| | Representative ISO 20022 | |
|---|---|---|
| Kernel field (canonical) | element | Notes (non-limiting) |
| from.namespace/account_id | Dbtr/Nm + DbtrAcct/Id | Alias directory; resolver |
| | | transcript digest may be |
| | | retained. |
| to.namespace/account_id | Cdtr/Nm + CdtrAcct/Id | Domain-anchored addressing |
| | | resolved to legacy identifiers. |
| amount_minor + currency | Amt/InstdAmt | Minor units; canonicalization |
| | | fixes decimal representation. |
| nonce | InstrId/EndToEndId (or | Nonce gate is kernel-side; |
| | local) | IDs remain informative. |
| timestamp_s | CreDtTm | Canonical time source and |
| | | rounding rules are profile- |
| | | defined. |
| policy_version_id | RmtInf/Strd (or local) | May be carried as structured |
| | | remittance or metadata. |
| mapping_version | Local/proprietary header | Detect downgrade or |
| | | mismatched mappings. |
| rail_payload_digest | Hash of serialized payload | Computed over canonical |
| | | serialization of outgoing |
| | | payload. |
| rail_ack_digest | Hash of status/advice | Computed over pacs.002 or |
| | | rail-specific |
| | | acknowledgements. |
| metadata_binding_hash | Out-of-band evidence | Binds update_digest to |
| | | committed ledger state. |

L.2 Conventional Identifiers (Routing/BIC/EUTR) as Evidence-Carrying Aliases (non-Limiting)

In certain embodiments, conventional identifiers (such as routing numbers, BICs, or tracking references) are treated as aliases mapped into domain-anchored namespace addressing. The kernel does not require replacing existing rails; rather it adds deterministic evidence objects enabling reconciliation and third-party audit.

| Conventional | | |
|---|---|---|
| identifier | Kernel handling | |
| (illustrative) | (illustrative) | EOU observables |
| ABA routing | Alias mapped via resolver | resolver_transcript_digest; |
| number | registry under | mapping_version |
| | mapping_version | |
| SWIFT BIC | Alias mapped to namespace | canonical_profile_id; |
| | anchor; may be metadata | tx_hash |
| UETR/tracking | Optional metadata bound | rail_payload_digest; |
| ref | under canonical profile | rail_ack_digest |
| Account | Resolved into account | proof_set_digest; |
| number/ | container; may be | audit_ptr |
| IBAN | encrypted attribute | |

### L.3 Security & Failure Semantics (Non-Limiting)

The kernel improves computer-implemented settlement integrity by ensuring deterministic inputs, deterministic failure receipts, and evidence binding across execution, rails, and governance.

Digest divergence mitigation: byte-identical canonical intent envelope under canonical_profile_id.

Replay prevention: nonce gate with deterministic failure receipt and auditable status_code.

Downgrade detection: mapping_version and schema identifiers (ack_schema_id; presence_rule_id) cause verification failure under mismatch.

Partial-commit prevention: two-phase bridging with explicit rail payload/acknowledgement digests.

Policy drift prevention: governance binder anchors update_digest and metadata_binding_hash to committed ledger state.

### L.4 Hardware-Backed Embodiments (HSM/TEE) (Non-Limiting)

In certain embodiments, canonical_profile_id, signing keys, and critical verification predicates are protected using hardware security modules (HSM) or trusted execution environments (TEE). Hardware-backed attestation may be recorded as an optional evidence field bound into receipt chains.

### L.5 Performance & Determinism Notes (Non-Limiting)

Canonicalization complexity is linear in message size; fixed field ordering enables constant-time validation of required fields.

Verifier recomputation is constant-time with respect to internal state, requiring only proof_set fields and (optionally) rail digests.

Offline capture/sync supports append-only buffers with hash chaining, enabling safe retries without ambiguity.

### L.6 Cross-Domain Embodiments (Energy/IoT/Healthcare) (Non-Limiting)

The same evidence-first deterministic execution model may be instantiated in non-financial domains where reconciliation, auditability, and policy traceability are required.

| | Representative | Key evidence objects |
|---|---|---|
| Domain | transaction intent | (illustrative) |
| Energy dispatch | dispatch_rights → | canonical_profile_id; |
| | settlement | policy_version_id; |
| | | proof_set_digest |
| IoT governance | device_action → | resolver_transcript_digest; |
| | authorization | offline_chain_digest; |
| | | status_code |
| Healthcare/ | minute_rights → | receipt_chain_digest; |
| telehealth | billing/claim | audit_ptr; governance |
| | | binding hash |

### L.7 Non-Limiting Diligence Notes for Licensing (EOU)

For diligence, a non-limiting indicator of use is the presence of any of: mapping_version, rail_payload_digest/rail_ack_digest, canonical_profile_id, update_digest, or metadata_binding_hash returned by a verification endpoint or carried in a receipt record, consistent with the Evidence-of-Use protocols in Annex F.

### L.8 Conformance Profile Template (Non-Limiting)

In certain embodiments, a conformance profile is represented as a versioned, machine-readable record that fixes canonicalization, hashing, schema presence rules, and verifier predicates. This enables deterministic interoperability and simplifies third-party diligence.

| | | Constraint (non- | |
|---|---|---|---|
| Field | Type | limiting) | Purpose |
| canonical_{—} | string | stable identifier; | Selects |
| profile_id | | versioned | canonicalization |
| | | | rules. |
| canonical_{—} | enum | e.g., UTF8_DELIM | Fixes serialization |
| format_id | | or BINARY_TLV | format. |
| delimiter | string | if format is delimiter- | Fixes byte boundary |
| | | based; e.g., ‘\|’ | rules. |
| hash_{—} | enum | e.g., HF_SHA256 | Fixes digest |
| function_id | | | algorithm. |
| ack_{—} | string | versioned schema | Interprets rail |
| schema_id | | identifier | acknowledgement |
| | | | payload. |
| presence_{—} | string | versioned; | Specifies which |
| rule_id | | deterministic | fields must be |
| | | | present. |
| mapping_{—} | string | monotonic per rail | Detects mapping |
| version | | adapter | downgrade. |
| verifier_{—} | string | points to predicate | Binds verification |
| predicate_id | | | logic. |
| status_code_{—} | string | closed set | Defines deterministic |
| schema_id | | | failure receipts. |
| profile_digest | bytes | H(profile_record) | Tamper-evident |
| | | | profile snapshot. |

Non-limiting note: profile_digest may be included (directly or indirectly) in receipt records or conformance records to enable external verification that the same profile was used.

### L.9 Evidence-of-Use Sampling Mini-Protoc (Non-Limiting)

The following mini-protocol is provided to illustrate a low-cost diligence workflow for identifying evidence-of-use signals without access to internal state.

Step 1: Obtain a tx_hash (from receipt, API, log, or user-visible transaction reference).

Step 2: Query a verification endpoint (or request an audit/receipt export) to obtain a proof_set.

Step 3: Check for presence of any of: canonical_profile_id, mapping_version, rail_payload_digest, rail_ack_digest, update_digest, metadata_binding_hash.

Step 4: Recompute settlement integrity H(previous_hash∥tx_hash) and compare to block_hash.

Step 5 (optional): If governance fields present, recompute H(block_hash∥update_digest) and compare to metadata_binding_hash.

| | | Why it is high-value for |
|---|---|---|
| Observed artifact | Typical acquisition channel | diligence |
| proof_set | verify endpoint/exported | Self-contained evidence |
| | receipt bundle | enables third-party |
| | | recomputation. |
| rail_payload_digest + | rail adapter logs/receipt | Binds legacy rails to |
| rail_ack_digest | metadata | deterministic kernel. |
| update_digest + | governance registry/ | Cryptographically anchors |
| metadata_binding_hash | versioned configs | policy evolution. |
| mapping_version | adapter header/receipt | Downgrade detection; anti- |
| | metadata | evasion signal. |

### L.10 Risk Vector Subset Anti-Design-Around (Non-Limiting)

In certain embodiments, the risk vector may be computed as a pure function over input attributes under a profile-defined schema. While a 32-dimensional vector is described in examples, subsets or supersets that are cryptographically bound to receipt evidence may be used without departing from the deterministic execution model.

| Pattern | Example (illustrative) | Evidence binding |
|---|---|---|
| Full vector | dim_01 . . . dim_32 | risk_vector_digest bound into |
| | | receipt_chain_digest |
| Subset | dim_03, dim_07, dim_12, | subset_digest + |
| | dim_19, dim_24 | dimension_set_id bound into |
| | | proof_set |
| Superset | dim_01 . . . dim_64 | extended_digest under |
| | | schema_id + |
| | | presence_rule_id |

Non-limiting note: a dimension_set_id (or schema_id) can be used to prevent evasion by silently changing the included dimensions while claiming functional equivalence.

### L.11 Governance Change Evidence Registry (Non-Limiting)

In certain embodiments, a governance change registry exposes versioned change records whose digests are bound to committed ledger state. This supports third-party validation of rule evolution and detection of off-ledger policy drift.

| Record | Fields (illustrative) | Binding |
|---|---|---|
| governance_{—} | policy_version_id; | metadata_binding_hash = |
| change_{—} | update_digest; | H(block_hash ∥ |
| record | effective_time; signer | update_digest) |
| mapping_{—} | mapping_version; | included in |
| change_{—} | rail_schema_id; | conformance_record |
| record | update_digest | profile_digest |
| emergency_{—} | halt_reason_code; | receipt_chain_digest |
| halt_record | scope; update_digest | references update_digest |

Downgrade detection: verifier rejects proofs whose policy_version_id or mapping_version is lower than a registry-declared minimum.

Traceability: regulator-authorized audit tools may compare exported receipts to registry snapshots without querying internal balances.

### L.12 Asset-Packaging Checklist for Licensing (Non-Limiting)

The following checklist is provided to facilitate efficient diligence and valuation when packaging this disclosure into an asset bundle for transfer or licensing.

| | Why it increases | |
|---|---|---|
| Item | valuation | Typical format |
| Core spec + drawings + | Defines scope and | PDF/DOCX |
| claims | enablement | |
| EOU diligence sheet | Reduces enforcement cost; | 2-3 page PDF |
| (Annex F summary) | black-box detection | |
| Conformance profiles + | Enables interoperability and | JSON/CSV + |
| test vectors | acceptance testing | PDF |
| Reference verifier | Accelerates buyer | Pseudocode/ |
| implementation (non- | validation | minimal code |
| production) | | |
| Module bank index | Signals defensible family; | 1-3 pages |
| (abbreviated) | cross-domain leverage | |
| Field-of-use licensing | Speeds negotiation; reduces | 1 page term sheet |
| options | ambiguity | |

Non-limiting note: none of the above items limits the claims; they are provided to reduce diligence friction and to support licensing discussions.

### L.8A Example Conformance Profile Record (Non-Limiting)

The following non-limiting example illustrates a concrete, machine-readable conformance profile record. Field names are illustrative and may be encoded as JSON, CBOR, or equivalent structured formats. The profile_digest is computed as H(canonical_bytes(profile_record)) under the selected hash_function_id.

```
{
  “canonical_profile_id”: “CP_01”,
  “canonical_format_id”: “UTF8_DELIM”,
  “delimiter”: “|”,
  “hash_function_id”: “HF_SHA256”,
  “ack_schema_id”: “ACKS_20022_PACS002_V1”,
  “presence_rule_id”: “PR_01_REQUIRED_FIELDS”.
  “mapping_version”: “MV_2026_03_01”,
  “verifier_predicate_id”: “VP_SETTLEMENT_V1”,
  “status_code_schema_id”: “SCHEMA_V1_OK_ERR”,
  “profile_digest”: “sha256:3b2f... (computed)”,
  “created_utc”: “2026-02-28T23:59:59Z”,
  “issuer_key_id”: “KID_ATMS_GOV_01”,
  “signature”: “sig:MEUCIQ... (optional)”
}
```

### L.8B Example Receipt Binding of Profile_Digest (Non-Limiting)

In certain embodiments, profile_digest is bound into receipt evidence to enable external verifiers to confirm the exact canonicalization rules used for tx_hash computation. The binding may be direct or indirect (e.g., via a conformance_record digest).

| Evidence | | Binding expression |
|---|---|---|
| object | Illustrative field(s) | (illustrative) |
| receipt_{—} | profile_digest, | tx_hash = |
| record | canonical_profile_id | H(canonical_bytes(intent; |
| | | profile)) |
| conformance_{—} | profile_digest, | conformance_digest = |
| record | verifier_predicate_id | H(profile_digest ∥ |
| | | verifier_predicate_id ∥ |
| | | test_vector_digest) |
| proof_set | profile_digest | block_hash = |
| | (optional), block_{—} | H(previous_hash ∥ tx_hash); |
| | hash | optionally include |
| | | profile_digest pointer |

Non-limiting note: storing canonical_profile_id plus a verifier-resolvable profile_digest pointer may reduce receipt size while preserving auditability.

### L.8C Worked Example Text Vector (TV_01) End-to-End Binding (Non-Limiting)

This non-limiting worked example shows an end-to-end chain from (i) conformance profile digest, to (ii) tx_hash, to (iii) block_hash, and (iv) optional governance binding. Values are illustrative; implementations may compute equivalent digests under profile-defined canonicalization and hashing rules.

| Item | Illustrative value/computation |
|---|---|
| canonical_profile_id | CP_01 |
| hash_function_id | HF_SHA256 |
| canonical_bytes_ascii | from=acct_A01\|to=acct_B01\|amount_minor= |
| | 10037\|currency=USDT\|nonce=1\|timestamp_s |
| | =1730000060 |
| profile_digest | sha256:3b2f... (computed over |
| | canonical_bytes(profile_record)) |
| tx_hash | sha256:9de6c6a54b08f4c5c5ab05bdd11f9a5f |
| | 5487c650ae3e9ca60dad287fe7b54366 |
| previous_hash | sha256:0000... (GENESIS or prior |
| | block_hash) |
| block_hash | sha256:H(previous_hash ∥ tx_hash) |
| | (computed) |
| mapping_version | MV_2026_03_01 (optional) |
| rail_payload_digest | sha256:... (optional, if legacy rail used) |
| rail_ack_digest | sha256:... (optional, if rail ack present) |
| update_digest | sha256:... (optional governance change) |
| metadata_binding_hash | sha256:H(block_hash ∥ update_digest) |
| | (optional) |

EOU indicator (non-limiting): presence of any of canonical_profile_id, mapping_version, rail_payload_digest/rail_ack_digest, update_digest, or metadata_binding_hash within a proof_set or receipt bundle is a strong black-box observable consistent with the kernel-level deterministic execution model.

### L.8D ASCII-Safe Recompute Block for TV_01 (Non-Limiting)

The following ASCII-safe block is provided so a verifier can reproduce the tx_hash deterministically using the indicated canonicalization profile. This block is illustrative and does not limit the claims.

TV_01_CANONICAL_BYTES_ASCII
canonical_profile_id=CP_01
hash_function_id=HF_SHA256
delimiter=|
record=
from=acct_A01|to=acct_B01|amount_minor=10037|currency=USDT|nonce=1|timestamp_s=1
730000060
RECOMPUTE_RULE (illustrative)
tx_hash = SHA256(UTF8(record))
expected_tx_hash_sha256 =
9de6c6a54b08f4c5c5ab05bdd11f9a5f5487c650ae3e9ca60dad287fe7b54366

Non-limiting note: equivalent structured encodings (e.g., CBOR TLV) may be used under a different canonical format_id; the determinism property derives from profile-defined canonicalization and hashing, not from a particular textual delimiter.

1. A computer-implemented system comprising:
(a) a namespace parser configured to resolve a namespace address into a hierarchical account graph comprising parent and child account nodes;
(b) an inheritance rule engine configured to compute, for a selected account node, an effective parameter set by applying a deterministic precedence rule set to inherited parameters and override parameters along a path within the hierarchical account graph;
(c) a snapshot generator configured to produce snapshot_id that binds at least (i) policy_version_id and (ii) an effective time window to the effective parameter set;
(d) a canonicalization profile engine configured to apply a declared canonicalization profile identified by canonical_profile_id to construct a byte-identical canonical intent envelope and to compute tx_hash using a hash function identified by hash_function_id;
(e) a unified payment routing key generator configured to generate a machine-executable routing key using at least snapshot_id and a key version, the routing key further including replay-prevention material and a time-to-live value;
(f) a deterministic risk finite-state machine configured to evaluate one or more risk constraints and to gate execution of a transaction prior to an atomic commit boundary, the deterministic risk finite-state machine emitting reason codes;
(g) a ledger execution engine configured to perform an atomic debit-credit transformation across account nodes at the atomic commit boundary with idempotency protection and concurrent access control, and to enforce a nonce gate associated with at least one account node;
(h) an audit log module configured to persist, in an append-only tamper-evident log, commitments to transaction inputs, evaluated constraints, tx_hash, and commit outcomes; and
(i) a settlement engine configured to apply a settlement matrix bound to the hierarchical account graph to distribute value among account nodes and to generate reconciliation records, wherein the system exposes a verification interface configured to return a proof set including at least tx_hash, hash_function_id, canonical_profile_id, snapshot_id, and anchor data for third-party recomputation.

2. A computer-implemented method comprising:
(a) receiving a namespace address;
(b) resolving, by a namespace parser, the namespace address into a hierarchical account graph;
(c) computing, by an inheritance rule engine, an effective parameter set for a selected account node using deterministic inheritance and override precedence rules;
(d) generating snapshot_id binding policy_version_id and an effective time window to the effective parameter set;
(e) canonicalizing, under canonical_profile_id, an intent into a byte-identical canonical intent envelope, computing tx_hash under hash_function_id, and verifying a digital signature over tx_hash;
(f) generating a unified payment routing key using at least snapshot_id;
(g) evaluating, by a deterministic risk finite-state machine, one or more risk constraints and gating execution prior to an atomic commit boundary while emitting reason codes;
(h) executing an atomic debit-credit transformation at the atomic commit boundary with idempotency protection and enforcing a nonce gate; and
(i) applying a settlement matrix bound to the hierarchical account graph to distribute value and record reconciliation outputs, and returning a proof set enabling third-party recomputation.

3. A non-transitory computer-readable medium storing instructions that, when executed by one or more processors, cause the one or more processors to:
(a) resolve a namespace address into a hierarchical account graph;
(b) compute an effective parameter set using deterministic inheritance and override precedence rules;
(c) generate snapshot_id binding policy_version_id and an effective time window;
(d) construct a byte-identical canonical intent envelope under canonical_profile_id and compute tx_hash under hash_function_id;
(e) generate a unified payment routing key using at least snapshot_id;
(f) gate a transaction using a deterministic risk finite-state machine prior to an atomic commit boundary;
(g) perform an atomic debit-credit transformation with idempotency protection and nonce gating;
(h) persist an append-only tamper-evident audit log and apply a settlement matrix bound to the hierarchical account graph; and
(i) provide a verification interface returning a proof set for third-party recomputation.

4. The system of claim 1, further comprising a legacy-rail adapter configured to perform a two-phase bridging sequence by (i) generating rail_payload_digest under mapping_version and (ii) generating rail_ack_digest over acknowledgement fields serialized in fixed order under ack_schema_id, wherein field presence within a defined acknowledgement-field set is uniquely determined by presence_rule_id.

5. The system of claim 1, wherein the legacy-rail adapter is further configured to apply jurisdiction_code_set derived from the namespace address to inject compliance constraints into adapter mapping rules.

6. The system of claim 1, wherein receipt_record metadata includes route_reason_code, policy_version_id, routing_rule_store_version, ack_schema_id, and presence_rule_id for audit replay of routing and compliance decisions.

7. The system of claim 1, wherein the inheritance rule engine uses an override precedence table comprising at least parent-default, role-based override, node-specific override, and emergency override.

8. The system of claim 1, wherein snapshot_id further binds a cache coherency token and a snapshot expiration time to prevent use of stale parameters.

9. The system of claim 1, wherein the unified payment routing key generator validates a digital signature and supports key rotation based on the key version.

10. The system of claim 1, wherein the unified payment routing key includes replay-prevention material configured to reject repeated routing requests within a validity window.

11. The system of claim 1, wherein the deterministic risk finite-state machine comprises states including NORMAL, RESTRICTED, FROZEN, ESCALATED, and REVIEW, and uses a state transition table.

12. The system of claim 1, wherein the reason codes include at least velocity-threshold, geofence violation, exposure-limit, policy-window-mismatch, signature-invalid, and endpoint-integrity-failure codes.

13. The system of claim 1, wherein the ledger execution engine enforces idempotency using an idempotency key bound to snapshot_id, the unified payment routing key, and tx_hash.

14. The system of claim 1, wherein the append-only tamper-evident log comprises a write-ahead log and a Merkle commitment structure for periodic integrity anchoring, and selectively computes block_hash as H(concatenation(previous_hash, tx_hash)).

15. The method of claim 2, wherein resolving the namespace address comprises retrieving a signed endpoint record and verifying the signed endpoint record prior to routing.

16. The method of claim 2, wherein evaluating risk constraints comprises computing a deterministic 32-dimensional behavioral risk vector comprising dim_i features and computing a RiskScore as a weighted sum of the dim_i features using weights w_i under policy_version_id bound by snapshot_id.

17. The method of claim 2, wherein generating snapshot_id comprises freezing a policy bundle version and canonical_profile_id for the transaction until completion of the atomic commit boundary.

18. The method of claim 2, wherein applying the settlement matrix comprises distributing a fee portion to a parent account node and a remainder to a child account node in a single commit cycle.

19. The non-transitory computer-readable medium of claim 3, wherein concurrent access control comprises optimistic concurrency using a version counter stored with each account balance record.

20. The non-transitory computer-readable medium of claim 3, wherein the instructions further cause: (i) offline operation to validate offline_pre_authorization_token hash-bound to namespace address, snapshot_id, credit_limit, expiry, and nonce within a validity window; (ii) a governance binder to compute update_digest for a mapping_version update payload and to record metadata_binding_hash=H(concatenation(block_hash, update_digest)); and (iii) generation of a conformance record and a receipt-verification interface configured to verify proof sets and rail digests against a published kernel profile and test vectors.
